(19) United States
(12) Patent Application Publication
(10) Pub. No.: US 2015/0024187 A1
(43) Pub. Date: Jan. 22, 2015

(54) METHOD OF MANUFACTURING PLASTIC ARTICLE

(71) Applicants: Omer Kutluoglu, Hertfordshire (GB); Turul Taskent, Hertfordshire (GB)

(72) Inventors: Omer Kutluoglu, Hertfordshire (GB); Turul Taskent, Hertfordshire (GB)

(21) Appl. No.: 14/369,058

(22) PCT Filed: Sep. 12, 2012
(86) PCT No.: PCT/GB2012/052252

§ 371 Date: Aug. 15, 2014

(30) Foreign Application Priority Data
Sep. 12, 2011 (GB) 1115724.5
Mar. 2, 2012 (GB) 1203682.8
Mar. 20, 2012 (GB) 1204867.4
May 14, 2012 (GB) 1208420.8

(51) Int. Cl. B32B 37/04; B32B 5/20

(52) U.S. Cl. CPC B32B 37/04; B32B 5/20; B32B 2305/022; B32B 2250/40; B32B 2305/70; B32B 2250/04
USPC 428/220; 156/245

(57) ABSTRACT

A process is provided for forming plastic into a predetermined shape from a plastic particulate material, and a heat-activated expandable foam plastic filler material, comprising the steps of: (i) providing first and second complementary mould parts; (ii) heating said first and second mould parts at least on their face portions such that the mould parts are at a temperature to make the plastic particulate material molten or sinterable; (iii) contacting the first and second mould parts with plastic particulate material; (iv) contacting the heat-activated expandable foam plastic filler material to the plastic particulate material; (v) melting or sintering at least a portion of the plastic particulate material on each mould part into a moulded skin; (vi) bringing together the complementary face portions of the heated first and second mould parts to form a composite sandwich.

### BACKGROUND OF THE INVENTION

1. Field of the Invention

The field of the invention relates to methods for forming plastic into a predetermined shape, to products which may be manufactured using such methods, and to computer program products operable to run on a computer to control such methods.

2. Technical Background

Plastic articles comprising a skin and a core are known, such as automotive and industrial vehicle components, and modular housing panels. However, the methods of manufacturing such articles have tended to be somewhat time consuming. Such methods have also tended to require significant energy.

3. Discussion of Related Art

In WO2002/062550A1, processes for forming plastic are described. Prior art FIG. 8 of WO2002/062550A1 shows a side elevational view of apparatus for utilizing an open mould. In FIG. 8 there is shown an illustration of an article and the respective process for manufacturing the article, generally denoted by the numeral 110. Mould 112 is shown as being formed to make a plate article with raised edges. Mould 112 is heated to an elevated temperature of greater than the melting point of the plastic particulates 116 held within container 114. It is disclosed in WO2002/062550A1 that if heating and cooling lines are used in carrier 118 or in mould 112 itself, then cooling fluids could be run through the lines, which would automatically contract the mould as it got cooler, pulling mould 112 away from a formed article.

FIG. 9 shows a perspective view in the open position of a plastic moulding machine for use in a method according to prior art reference GB2460838A. In FIG. 9, machine 10 comprises upper and lower mould halves 12, 14. The mould halves 12, 14 are joined by hinges 16 so that the mould halves can be moved between the open position seen in FIG. 9 and a closed position. Each mould half 12, 14 comprises a mould 18, 20 defining a mould cavity 22, 24 for forming a plastic article. Insulating jackets 30, 32 are shown in FIG. 9.

In WO2002/062550A1, Claim 12 therein discloses plastic particulate material being melted to form a skin on male and female complementary moulds, after which the two complementary male and female moulds are spaced apart from one another at a predetermined distance such that the plastic filler material may be sandwiched between the male and female moulds to form a double skinned composite with a plastic filler material in the middle of the two skins.

In GB2460838A, Claim 7 therein discloses that plastic particulate material is melted to form a skin on the moulds, after which expandable filler material is placed on the plastic skin formed in one mould.

Methods disclosed in WO2002/062550A1 and in GB2460838A have the disadvantage that skins must be formed first before filler material is added to the mould.

In addition, it is desirable for some applications to provide a skin structure which does not consist of a single skin with a uniform composition. A more complex skin structure, such as consisting of two or more layers, can provide advantages. For example, an outer skin can be provided which provides one or more of added strength, selected colour, odor, deodor, fire resistance, UV stabilizers, ready-releasable properties (eg. for forming applications), or a smooth surface finish (eg fewer or no surface pits due to contaminants in recycled plastics of an inner skin). An inner skin can be provided which does not possess these properties, but which has a lower cost per unit volume than the outer skin, for example because it is derived from recycled materials. Therefore a two layer skin can have the advantage of the outer skin property, and the advantage of a lower overall cost due to a lower cost per unit volume of the inner skin material than the outer skin material, where the outer skin material may be more expensive due to the property it provides. In addition, the inner skin may bind better to a core material than the binding which would be obtained between the outer skin and the core material, which reduces the risk of post-manufacture delamination between layers in a layered article.

In WO2002/062550A1, page 12 lines 2 to 3 therein disclose “Generally, the expandable foam is activated by the residual heat from the molds.” The use of residual heat is also referred to on pages 18, 20 and 27 therein. The use of residual heat leads to a relatively slow manufacturing process when compared to active heating and cooling. In WO2002/062550A1 FIG. 5 and related disclosures on pages 19 and 20 therein disclose a process for manufacturing an article using plastic particulate material in a pair of moulds. However, the process of FIG. 5 therein is disclosed to require 60 minutes, and the mould parts are disclosed to be apart for the first 28 minutes of the process. The extended process while the mould parts are apart leads to heat loss from the mould, which reduces energy efficiency and increases manufacturing time because heating is slowed down due to heat loss. Furthermore in WO2002/062550A1 FIG. 5 the mould parts are cooled while together which keeps the cooling rate of the mould and its contents low, which also increases manufacturing time.

In GB2460838B, Claim 1 therein discloses that moulds are first heated while open, then a material to form a skin is added, then one waits for a skin to form, then filler material is added, and then the mould is closed. The extended process while the mould is open leads to heat loss from the mould, which reduces energy efficiency and increases manufacturing time because heating is slowed down due to heat loss. Furthermore the moulds are cooled while completely closed which keeps the cooling rate of the moulds and its contents low, which also increases manufacturing time.

Methods disclosed in WO2002/062550A1 and in GB2460838B have the disadvantages of providing a relatively lengthy manufacturing cycle and of providing a relatively low energy efficiency.

### SUMMARY OF THE INVENTION

According to a first aspect of the invention, there is provided a process for forming plastic into a predetermined shape from a plastic particulate material, and a heat-activated expandable foam plastic filler material, the process comprising the steps of:

(i) providing first and second complementary mould parts, the mould parts being formed into a predetermined shape with at least a face portion on each of said complementary first and second mould parts to impart a desired shape;

(ii) heating said first and second mould parts at least on their face portions to an elevated temperature of from about 100° C. to about 500° C. such that the mould parts are at a temperature to make the plastic particulate material molten or sinterable;

(iii) contacting the first and second mould parts with plastic particulate material;

(iv) contacting the heat-activated expandable foam plastic filler material to the plastic particulate material on a face portion of at least one of the two complementary heated mould parts;

(v) melting or sintering at least a portion of the plastic particulate material on each mould part into a moulded skin of a plastic article having a skin of a desired thickness of from about 0.001 cm to about 3.0 cm, and

(vi) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

The process may be one wherein the plastic particulate material is recycled plastic.

The process may be one wherein the recycled plastic is comingled contaminated recycled plastic.

The process may be one wherein the plastic particulate material is non-recycled plastic.

The process may be one wherein material introduced into the mould further includes elastomeric material.

The process may be one wherein material introduced into the mould further includes rubber.

The process may be one wherein one mould part is flat, and the other mould part is hollow.

The process may be one wherein both mould parts are hollow.

The process may be one wherein the heating in step (ii) is performed with the mould closed, and when a target temperature is reached, the mould is opened for application of plastic particulate material.

The process may be one wherein during step (vi) the first and second mould parts are actively heated.

The process may be one wherein during step (vi), the process does not rely on the residual heat of the mould parts.

The process may be one wherein the quantities of plastic particulate material and heat-activated expandable foam plastic filler material used are such that when those materials are fully expanded, the volume of the article is greater than the volume of the mould, and wherein some material from the article oozes out the mould as the article is formed.

The process may be one wherein during step (vi), the mould temperature is at a maximum at a place not near to the edge of the mould, and the mould temperature decreases between that place and the edge of the mould.

The process may be one wherein during step (vi), the mould temperature is at a maximum at or near to the centre of the mould, and the mould temperature decreases between that place and the edge of the mould.

The process may be one wherein a maximum temperature in step (ii) is one of: 400° C., 300° C., 260° C., 250° C., or 200° C.

The process may be one wherein in step (ii), entire mould parts are heated.

The process may be one wherein the moulds are made of a material selected from the group consisting of aluminium, aluminium alloys, stainless steel, kirksite, metals, ceramics, cermets, high temperature plastics, formable heat resistant materials, nickel alloys, or pyrex glass.

The process may be one wherein the plastic article is a board.

The process may be one wherein the board is no less than 2 feet×2 feet.

The process may be one wherein the board is no bigger than 15 feet×10 feet.

The process may be one wherein the board is no thicker than 200 mm.

The process may be one wherein the board is no thicker than 80 mm.

The process may be one wherein the board is no thinner than 4 mm.

The process may be one wherein the board includes inserts in the core or skin layers.

The process may be one wherein the board includes inserts on top of the skin layers or between the core and skin layers.

The process may be one wherein the plastic particulate material includes a blend of plastics.

The process may be one wherein the heat-activated expandable foam plastic filler material includes heat-activated expandable foamable plastic filler material.

The process may be one wherein during step (vi), during core foaming, the core bonds to the skins.

The process may be one wherein during step (vi) the mould is slightly open where the face portions meet so that the inside of the mould is at atmospheric pressure.

The process may be one wherein during step (vi) the mould is slightly open where the face portions meet so that the inside of the mould is in communication with atmospheric pressure.

The process may be one wherein during step (vi) the mould is first closed, wherein foaming of the core causes a pressure-induced leakage from the mould above a threshold pressure, and wherein the threshold pressure is in the range 0.5 bar to 5 bar in excess of atmospheric pressure.

The process may be one wherein the process is a manufacturing process tolerant to the compositions of the plastic particulate material and the heat-activated expandable foam plastic filler material.

The process may be one the process including a step in which the article is removed from the mould, the process including a further finishing step wherein the article removed from the mould is trimmed around its edges to provide an article with more neatly finished edges.

The process may be one wherein the temperature of the mould parts is increased or decreased as required during the manufacturing process by flowing temperature-controlled oil through channels in the mould parts, and wherein the channels are arranged in the mould parts to achieve a higher temperature near to the centre of the mould and a lower temperature at a mould edge, and wherein during step (vi) a foaming process begins near the mould centre, and spreads out to a mould edge.

According to a second aspect of the invention, there is provided a computer program product for running on a computer, wherein the computer program product running on a computer is operable to control a process according to a first aspect of the invention.

According to a third aspect of the invention, there is provided a plastic article board comprising recycled plastic, the board comprising a core, an upper skin layer and a lower skin layer, the core bonded to the upper skin layer and to the lower skin layer, the board having an area no less than 2 feet×2 feet, and no greater than 15 feet×10 feet, wherein the board is no thicker than 200 mm and no thinner than 4 mm, wherein the board thickness non-uniformity across the board is less than ±5%.

The board may be one wherein the board thickness non-uniformity across the board is less than ±2.5%.

The board may be one wherein the board is no thicker than 80 mm.

The board may be one wherein the board thickness is in the range of 10 mm to 30 mm.

The board may be one wherein the recycled plastic is comingled contaminated recycled plastic.

### BRIEF DESCRIPTION OF THE DRAWINGS

FIG. 1 shows a schematic diagram of a cross-sectional view of an example of an upper mould and lower mould, each mould loaded with respective materials for forming a plastic article, in an open configuration. The closure direction of the mould is indicated.

FIG. 2 shows a schematic diagram of a cross-sectional view of an example of an upper mould and lower mould, each mould loaded with respective materials for forming a plastic article, in an open configuration. The closure direction of the mould is indicated.

FIG. 3 shows an example of a plastic article formed using the mould parts of FIG. 2, after a finishing step.

FIG. 4 shows a schematic diagram of a cross-sectional view of an example of an upper mould and lower mould in a nearly-closed configuration. As indicated, the mould is slightly open, so that excess material can ooze out, and so gas can escape.

FIG. 5 shows a schematic diagram of an example of a mould part 50 in plan view. Temperature-controlled oil is introduced into channels 52 in the mould part interior. The oil flows through the channels, and through connector pieces 51 which connect individual channels, and out through the exits indicated.

FIG. 6A shows schematically an example of an advancing front for the initiation of a foaming process within a mould.

FIG. 6B shows schematically an example of a temperature profile along a mould axis of FIG. 6A during a manufacturing process.

FIG. 7 shows an example of thicknesses of layers of a plastic article during a manufacturing process.

FIG. 8 shows an illustration of an article and the respective process for manufacturing the article, generally denoted by the numeral 110, according to prior art reference WO2002/062550A1.

FIG. 9 shows a perspective view in the open position of a plastic moulding machine for use in a method according to prior art reference GB2460838A.

FIG. 10 shows an example of a process used in preparing materials for manufacturing plastic articles using recycled plastic input materials, for use in plastic particulate moulding or in a similar process.

FIG. 11 shows an example of apparatus which may be used in an aggregate manufacturing cycle process, in plan view.

FIG. 12 shows an example of heating upper and lower mould parts in a brought-together configuration.

FIG. 13 shows an example of cooling mould parts in an open configuration to a mould starting temperature.

FIG. 14 shows a schematic diagram of a cross-sectional view of an example of an upper mould and lower mould, each mould loaded with respective materials for forming a plastic article, in an open configuration. The closure direction of the mould is indicated.

FIG. 15 shows a schematic diagram of a cross-sectional view of an example of an upper mould and lower mould, each mould loaded with respective materials for forming a plastic article, in an open configuration. The closure direction of the mould is indicated.

FIG. 16 shows an example of cooling mould parts in an open configuration to a mould starting temperature.

### DETAILED DESCRIPTION

### I. Method of Manufacturing Plastic Article eg. a Board

There are provided methods of manufacturing plastic articles which are well-suited to the use of recycled plastics in the manufacturing method, but which are not necessarily limited to the use of recycled plastics.

In an example, different plastics are used in the present manufacturing methods. One example is styrenic polymers. Examples include polystyrene (PS), acrylonitrile butadiene styrene (ABS), and high-impact polystyrene (HIPS). Other examples of different plastics include poly-olefins, eg. polyethylene (PE) and polypropylene (PP). Different plastics may be blended in examples of the present manufacturing methods.

In an example recycling process, plastics to be recycled are sorted into relatively hard plastics and relatively soft plastics. Plastics in each class then undergo cleaning to remove excess dirt, food waste, sticky labels, and the like. Plastics in each class are then shredded into pieces with a characteristic size of less than about 50 mm, then granulated into pieces with a characteristic size of less than about 10 mm. Pieces may be turned into finer grains (eg. characteristic size less than 2 mm) for use in a manufacturing process.

In an example, the relatively soft plastics may be used to form a skin of an article manufactured using the manufacturing methods disclosed, while the relatively hard plastics may be used to form a core of an article manufactured using the manufacturing methods disclosed. However, such an arrangement may lead to an article surface which is softer than desired (eg. more prone to scratches or tearing), and to a core which is more brittle than desired eg. too likely to crack under mechanical shock. Consequently, in the manufacturing methods disclosed, the skin may be formed using a blend of the relatively soft and relatively hard plastic materials, and the core may also be formed using a blend of the relatively soft and relatively hard plastic materials, but where the surface comprises relatively more soft plastic materials than the core. Other materials may be added to a blend of relatively soft plastics materials and relatively hard plastics materials: an example is that rubber may be added for impact resistance.

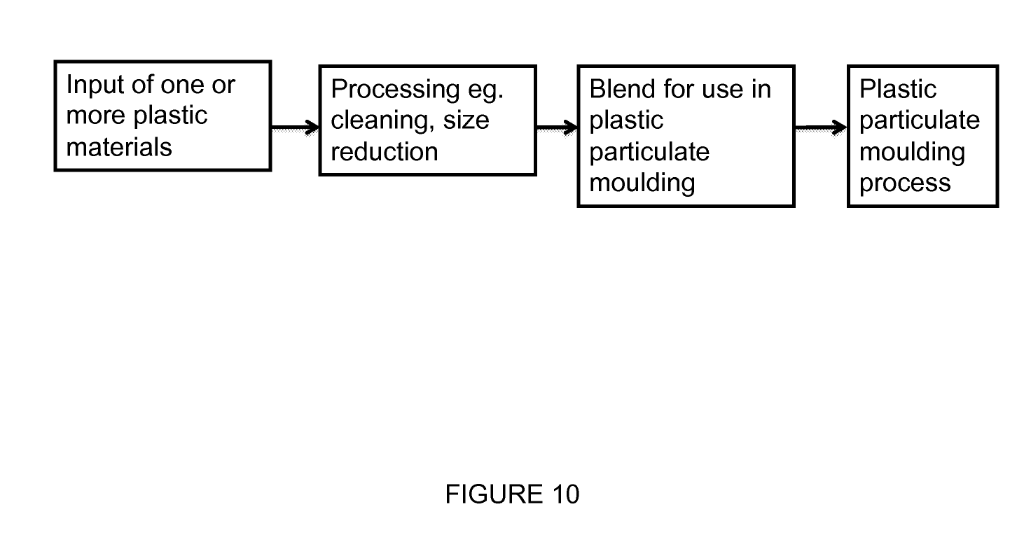

FIG. 10 shows an example of a process used in preparing materials for manufacturing plastic articles using recycled plastic input materials, for use in a plastic particulate moulding type manufacturing process, or in a similar process. Different input streams of input materials may be used, such as from different suppliers of recycled plastic input materials, for example. Different input streams may be used in parallel in the same manufacturing process, for example. Other input streams are possible, such as contaminated materials, or non-polymer filler materials, such as talc, stone or minerals for example. As an alternative, virgin materials may be used.

The materials used to form a skin of an article manufactured using the manufacturing methods disclosed may comprise plastic particulate material. The materials used to form a core of an article manufactured using the manufacturing methods disclosed may comprise heat-activated expandable foam plastic filler material. Heat-activated expandable foam plastic filler material may include or comprise heat-activated expandable foamable plastic filler material. Such heat-activated expandable foam plastic filler material will typically include a foaming agent. Known foaming agents include blowing agents and surfactants. There are two main types of blowing agents: those which are gases at the temperature at which the foam is formed and those that generate gases by a chemical reaction. Carbon dioxide, pentane, steam and chlorofluorocarbons are examples of the former. Blowing agents that produce gas via chemical reactions include baking powder, sodium bicarbonate, az odicarbonamide, hydroxypropane tricarboxylic acid and titanium hydride. The materials used to form the skin and/or core may comprise any of powder, pellets, shavings, chunks or the like.

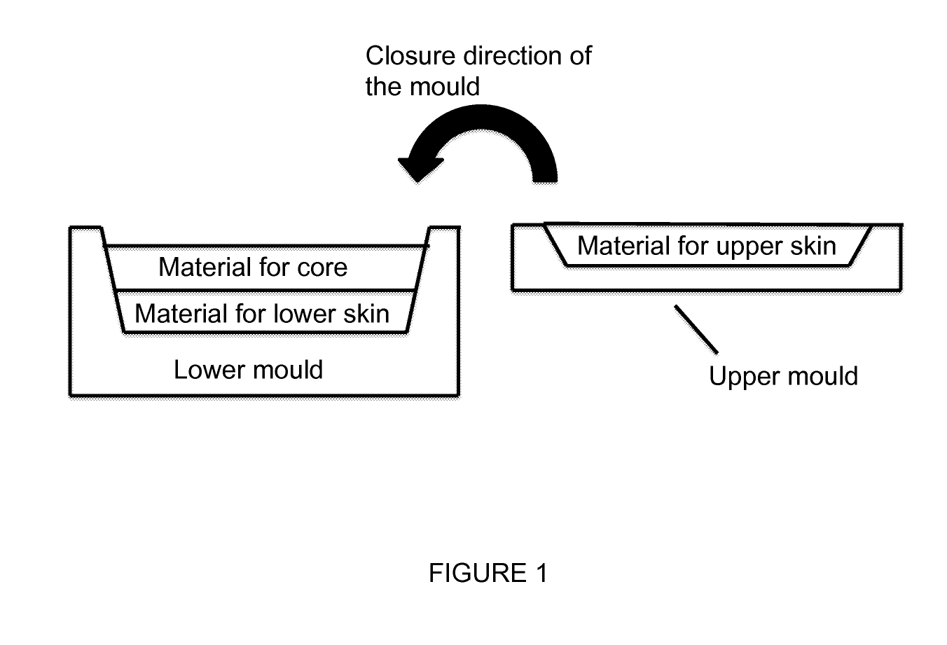

FIG. 1 shows an example of an arrangement of mould parts for use in a process for manufacturing a plastic article; the mould parts are suitable for use in a process for forming plastic into a predetermined shape from a plastic particulate material, and a heat-activated expandable foam plastic filler material. The upper skin and the lower skin may be formed using plastic particulate material as starting material. The core may be formed using a heat-activated expandable foam plastic filler material. In FIG. 1, the material for the core does not yet fill the lower mould, because the heat-activatable expandable foam plastic filler material has not yet been heat-activated. Release agents or coatings may be applied to the upper mould and lower mould surfaces in FIG. 1 prior to depositing the material for forming the respective upper skin and lower skin. Mould parts may be pre-coated with release agents or coatings prior to application of plastic particulate material. This facilitates removal of the manufactured article from the mould.

In FIG. 1, the upper mould and lower mould are examples of respective first and second complementary mould parts. The mould parts can be brought together or into close proximity such as to be able to form a moulded article.

The upper and lower mould parts can be heated entirely or at least on their face portions to an elevated temperature of from about 100° C. to about 400° C. or 500° C. such that the mould parts are at a temperature to make the plastic particulate material molten or sinterable.

In a method of manufacturing a plastic article, the upper and lower mould parts are brought into contact with plastic particulate material. For example, such material may be deposited from above, (eg. from a hopper), the material dropping from above to the respective mould surface under the force of gravity.

In a method of manufacturing a plastic article, the heat-activated expandable foam plastic filler material can be deposited onto the plastic particulate material on a face portion of at least one of the two complementary heated mould parts. Deposition processes can be computer-controlled. For example, in FIG. 1, the material for forming the core has been deposited onto the material for forming a lower skin. For example, such material may be deposited from above, eg. from a hopper, the material dropping from above to a mould part under the force of gravity. The heat-activated expandable foam plastic filler material can be deposited onto the plastic particulate material while the plastic particulate material is still in plastic particulate form ie before the plastic particulate material has undergone melting or sintering. This provides a faster deposition process than waiting (eg. for a dwell time) for the plastic particulate material to undergo melting or sintering before depositing the heat-activated expandable foam plastic filler material. However, for the skin of the final article to be hole-free, the deposition process of the plastic particulate material should provide plastic particulate material in a sufficiently uniform way over the mould part surface, so that the skin of final article does not have holes through which the core is visible. Also, plastic particulate material may be deposited such that there is no need to cease contact with (eg. to blow away or to vacuum up) excess plastic particulate material, because the deposited plastic particulate material is used to form the skins of the plastic article.

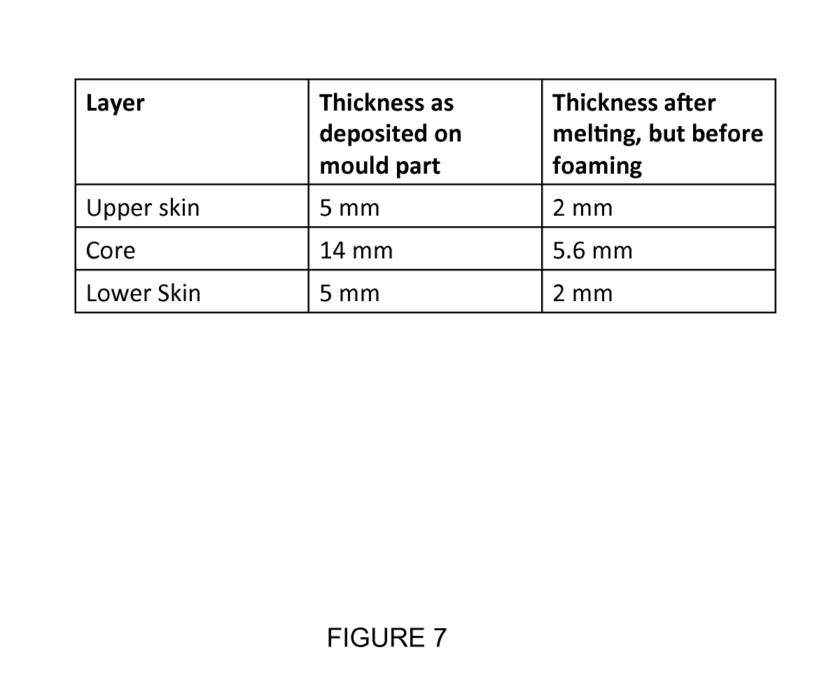

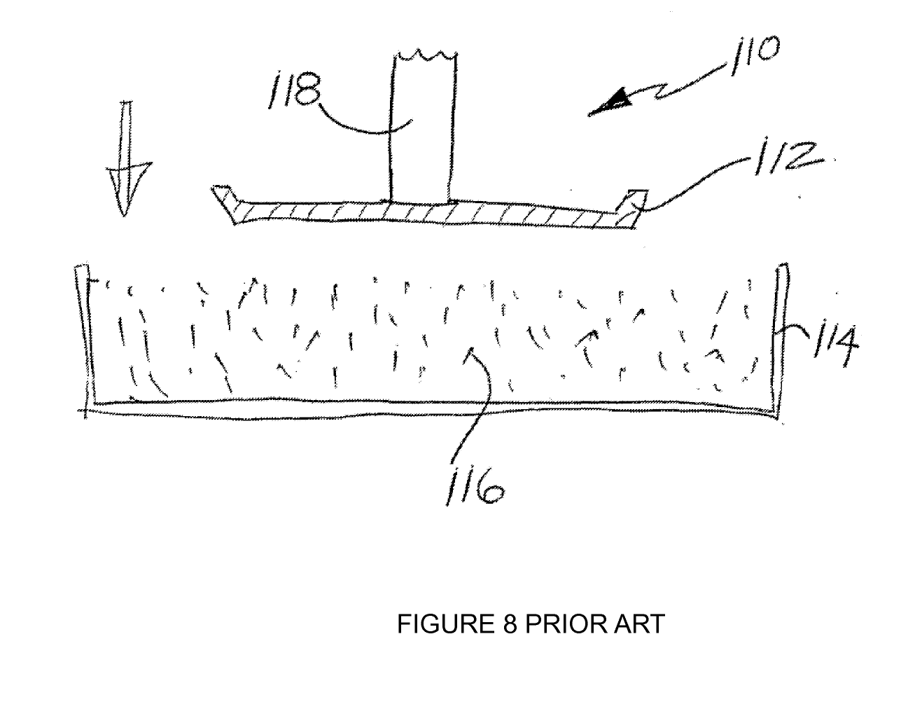

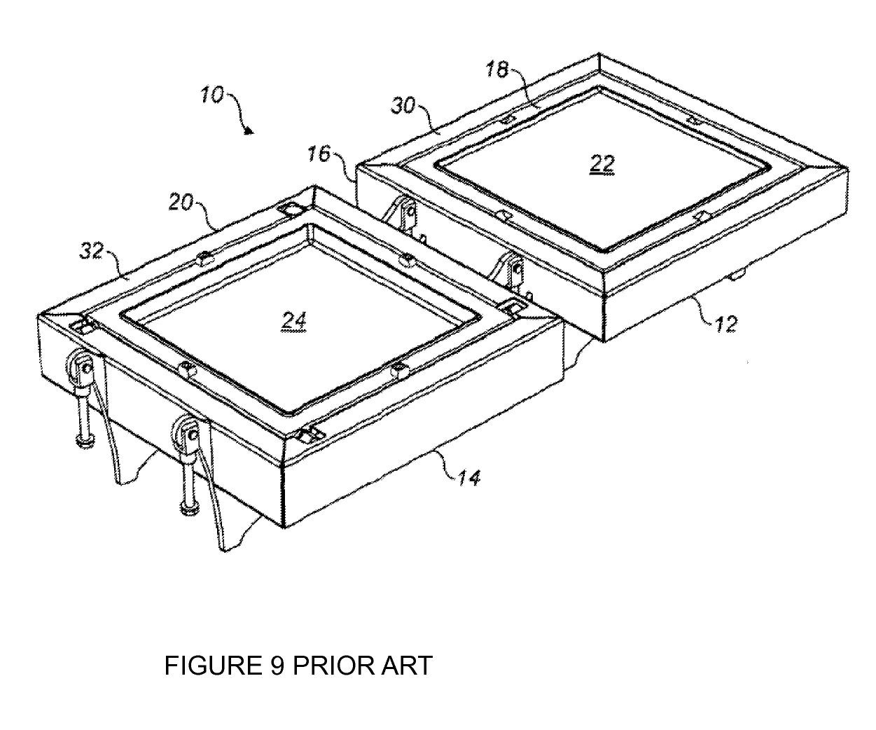

At least a portion of the plastic particulate material for forming a plastic article skin can melt or be sintered on each mould part into a moulded skin of a plastic article. The skin can have a desired thickness of eg. from about 0.001 cm to about 3.0 cm. FIG. 7 shows an example of thicknesses of layers of a plastic article during a manufacturing process. The skin may have a thickness in excess of any of the following thicknesses: 0.02 mm, 0.05 mm, 0.1 mm, 0.2 mm, 0.5 mm, 1.0 mm, 2.0 mm, 5.0 mm, 1.0 cm, 2.0 cm. Thicker skins have the advantage of being more robust against tearing, cracking, and may provide stiffer boards.

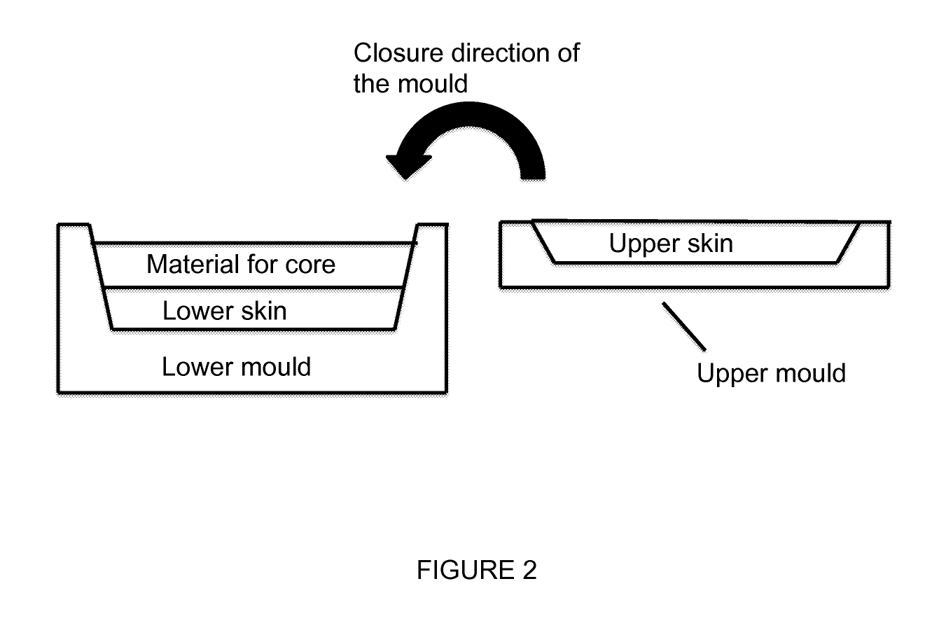

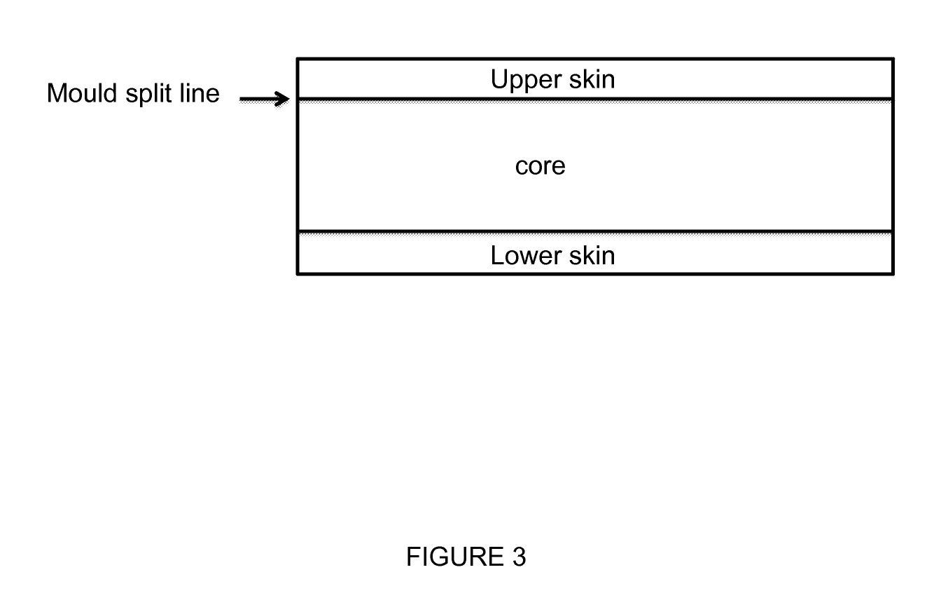

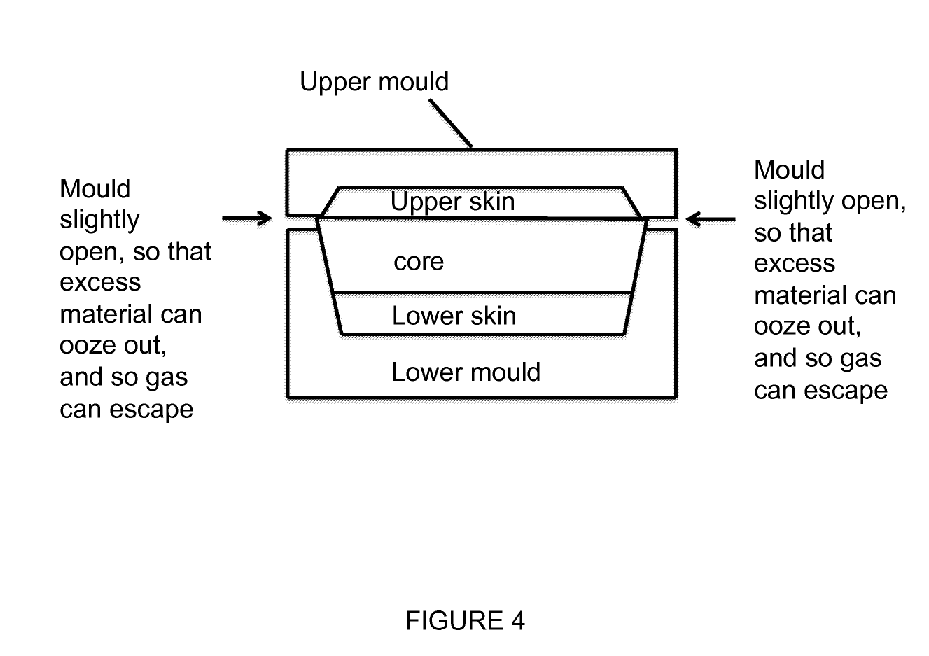

The complementary face portions of the heated first and second mould parts can be brought together, or into close proximity, for example as indicated in FIG. 2 by the thick arrow. The bringing together of the mould parts can be computer controlled. The upper mould may be moved using hydraulic equipment, electric motors, rotary actuators, rack and pinion, gearboxes, or a combination of these. During movement of the upper mould in the mould closure direction, the upper skin can remain attached to the upper mould if there is sufficient adhesion between the upper skin and the upper mould. During movement of the upper mould in the mould closure direction, the upper skin may not deform appreciably under gravity if the upper skin is sufficiently viscous not to deform under gravity as the upper mould is brought into position above the lower mould. The moulds may be heated or cooled by flowing temperature-controlled oil through channels in their interior. The heat from the heated mould parts will activate the heat-activated expandable foam plastic filler material to cause it to form a composite sandwich such that an article is formed having a moulded surface on both sides. During core foaming, the core bonds to the upper skin. An example of an article (eg. a board) formed by such a method is shown in FIG. 3. The article comprises a core sandwiched between a lower skin and an upper skin. The mould split line corresponding to the moulding process of FIG. 4 is indicated in FIG. 3.

The mould parts may be made of a material selected from the group consisting of aluminium, aluminium alloys, stainless steel, kirksite, metals, ceramics, cermets, high temperature plastics, formable heat resistant materials, nickel alloys and pyrex glass.

Aluminium alloys are suitable because they have good thermal conductivity, and because they are low in density (which facilitates moving the upper mould into position in close proximity or in contact with the lower mould, as indicated for example in FIG. 2), and because they do not deform appreciably at temperatures used in the moulding processes. Stainless steel is suitable, because it is mechanically very robust and therefore does not deform appreciably at temperatures used in the moulding processes. Nickel alloys are suitable because they include very hard materials which therefore do not deform appreciably at temperatures used in the moulding processes. Pyrex glass or ceramic mould parts may be suitable if the materials used in a manufacturing process include particularly corrosive substances.

Plastic particulate material may be recycled plastic. Recycled plastic may be comingled contaminated recycled plastic. Recycled plastic material may be comprised of comingled polymer which may include contaminants, fillers and additives. Recycled plastic is advantageous because it is low cost, abundant and because recycling is environmentally beneficial. Recycled plastic comprising a single type of polymer may lead to more reproducible manufactured products.

Plastic particulate material may be non-recycled plastic. Non-recycled plastic may be virgin polymer. Non-recycled plastic may lead to more reproducible manufactured products.

Material introduced into the mould may further include elastomeric material, or rubber eg. to provide impact resistance in the finished product.

The mould may be pre-heated prior to depositing material for forming the upper and lower skins of the article. Such heating may be performed with the mould closed, to reduce heat loss from the mould, which provides for a more energy-efficient manufacturing process, and which provides for more rapid heating of the mould. When a target temperature is reached, the mould may be opened for application of plastic particulate material suitable for forming skins of the article.

In an example, one mould part is flat, and the other mould part is hollow. This has the advantage of being a simple mould to design and manufacture. In another example (eg. FIG. 2), both mould parts are hollow. This has the advantage that the finished product is easier to remove from the open mould, because a relatively lower fraction of it is in contact with the lower mould.

When the mould parts are brought together after deposition of the materials to form a product comprising the upper skin, the core and the lower skin, the mould may be slightly open where the face portions of the upper mould and lower mould meet so that the inside of the mould is at atmospheric pressure, or in communication with atmospheric pressure. This can enable excess material to ooze out the mould, and can enable gas to escape, for example as indicated schematically in FIG. 4. Excess material may ooze into bleed channels.

In an alternative to FIG. 4, when the mould parts are brought together after deposition of the materials to form a product comprising the upper skin, the core and the lower skin, the mould may be closed but not sealed. During foaming of the core, the excess pressure caused by gas release may create a pressure-induced leakage from the mould, above a threshold pressure. The pressure-induced leakage may result from excess pressure pushing the mould parts slightly apart. The threshold pressure may be between 0.5 bar and 5 bar in excess of atmospheric pressure. (1 bar=10⁵ Pa). In an example, the threshold pressure is 0.7 bar in excess of atmospheric pressure. The pressure-induced leakage can enable excess material to ooze out the mould, and can enable gas to escape. In an example, in which lower skin material is deposited leaving a gap between the skin material and a side wall of the lower mould, excess material may ooze into the gap, and gas may be released from the mould after the gas pressure in the mould exceeds a threshold pressure.

When the mould parts are brought together to form the plastic article, the first and second mould parts may be actively heated. The manufacturing process may not rely on the residual heat of the mould parts from earlier heating. This provides improved temperature control, including of heating and cooling rates, during manufacturing, and for controlled activation of blowing agents.

The quantities of plastic particulate material and heat-activated expandable foam plastic filler material used in the process for manufacturing the plastic article may be such that when those materials are fully expanded (eg. after the expandable foam plastic filler material has been heat-activated), the volume of the article is greater than the volume of the mould. As a result, some material from the article oozes out the mould as the article is formed. Oozing material may go into an overspill channel in the mould. Such a system provides a tolerant manufacturing process; this is especially useful when recycled materials are used, because their properties will vary as the process is repeated. The wide variety of plastics which can be used lead to unpredictable amounts of expansion in the core during manufacture. The exact properties of the recycled plastic tend to be somewhat unpredictable. This is in contrast to many manufacturing processes, in which significant tolerance to varying input material properties is not required, because very well-defined input material properties are provided.

The manufactured plastic article may be a board. The board may be no less than 2 feet×2 feet. (2 feet×2 feet=60.96 cm×60.96 cm). The board may be no bigger than 15 feet×10 feet. (15 feet×10 feet=457.2 cm×304.8 cm). The board may be no thicker than 200 mm. The board may be no thicker than 80 mm. The board may be no thinner than 4 mm. The board may include inserts in the core or skin layers eg. to provide mechanical strength or impact resistance. The board may include inserts on top of the skin layers or between the core and skin layers eg. to provide mechanical strength or impact resistance. The board may include inserts on top of an additional plastic layer eg. an extruded layer. The board can be stamped or branded with a mark. The board may be only square or rectangular.

In a finishing step, the article produced from the mould may be trimmed around its edges to provide an article with more neatly finished edges. Waste material from the trimming can be recycled into the manufacturing process, which reduces waste.

Before depositing the plastic particulate material on the mould parts, the plastic particulate material may be at least at room temperature.

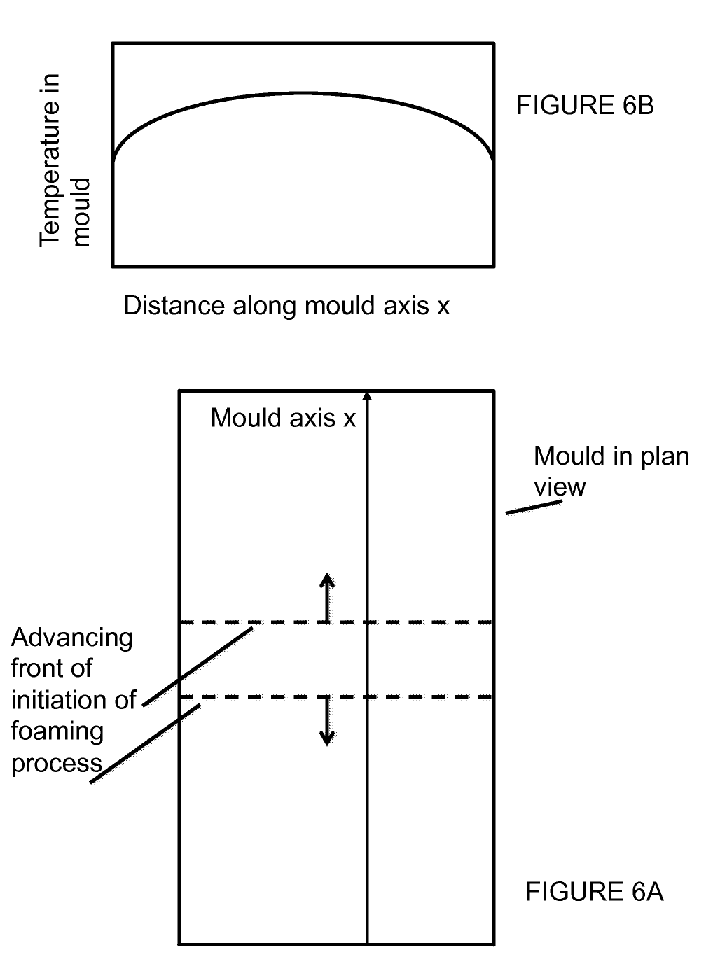

When the heat-activated expandable foam plastic filler material is heat-activated, the mould temperature may be at a maximum at a place not near to the edge of the mould, and the mould temperature may decrease between that place and the edge of the mould. When the heat-activated expandable foam plastic filler material is heat-activated, the mould temperature may be at a maximum at or near to the centre of the mould, and the mould temperature may decrease between that place and the edge of the mould. An example of a temperature profile within a mould at a given time is shown in FIG. 6B.

The maximum mould temperature during the manufacturing process may be 300° C., or less, 260° C. or less, 250° C. or less, or 200° C. or less. During heating of the mould parts, the entire mould parts may be heated. This can reduce thermally-induced stresses.

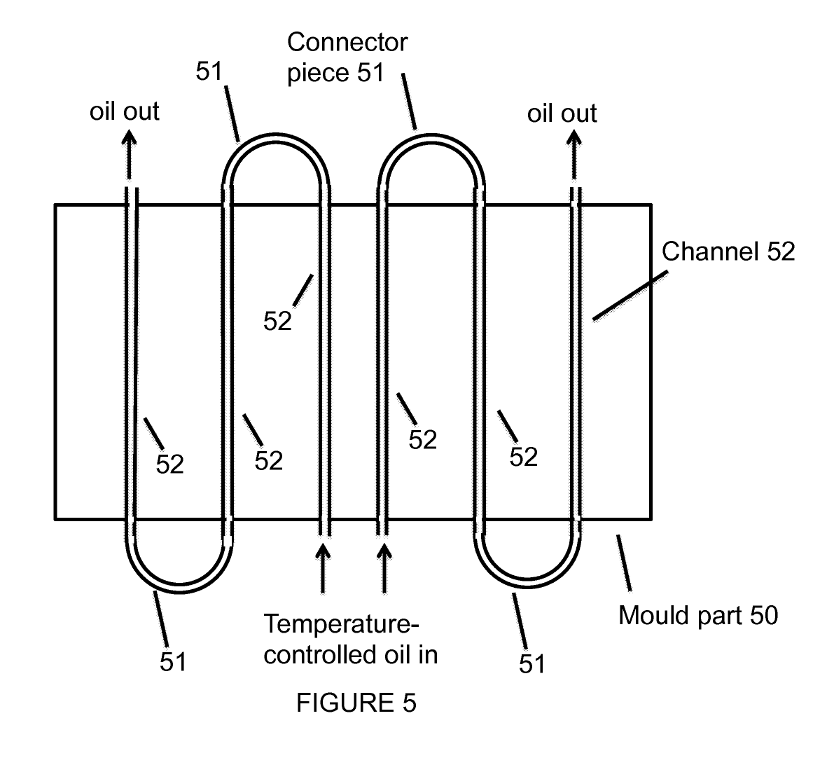

FIG. 5 shows a schematic diagram of an example of a mould part 50 in plan view. Temperature-controlled oil is introduced into channels 52 in the mould part interior. The oil flows through the channels, and through connector pieces 51 which connect individual channels, and out through the exits indicated. Diverter plates may be used instead of connector pieces. Connector pieces 51 may be made of the same or similar material to the mould part 50. The oil flows through a temperature-controlled circuit to be re-introduced into the mould part at a desired temperature. By flowing temperature-controlled oil through the mould part, the mould temperature can be increased or decreased as required during the manufacturing process. Temperature control can be computer-controlled. The arrangement of the channels in FIG. 5 can help to achieve a higher temperature near to the centre of the mould and a lower temperature at a mould edge because the place where oil is introduced is relatively close to a centre of the mould part along a side of the mould. This can help the foaming process to begin near the mould centre, and then to spread out to the mould edge, which helps the gases formed to escape from the mould edge, as would be understood by the skilled person for example with reference to FIG. 4. The spreading out of the foaming process towards the mould edge helps gases to escape, which helps to prevent the formation of significant bubbles in the manufactured plastic article, which might otherwise form due to trapped gases. An advancing front for the initiation of the foaming process within the mould is indicated by way of example schematically in FIG. 6A, in which the mould is shown in plan view, in transparency. Air is pushed out of the mould by blowing agent gas and as the core expands due to foaming processes. In an example, bubbles formed in the manufactured plastic article are small and are closed cell. In an example, air is prevented from flowing into the plastic article during manufacture because the viscosity of the plastic article core during manufacture is relatively high.

Precise control of the temperature of oil as it enters the mould parts, as shown for example in FIG. 5, together with the spatial arrangement of the channels 52 in which the oil flows, permits precise control of the temperature of a mould part 50 and the temperature distribution within a mould part 50. This provides for controlled activation of blowing agents. The precise control provides plastic articles comprising recycled plastic whose properties are precisely controlled, such as limiting thickness non-uniformity. This in turn permits the manufacture of articles with a relatively low thickness in proportion to their width and breadth, because a greater thickness is not required to average out non-uniform properties. Thickness non-uniformity for a particular article, across the article (eg. a 18 mm thick board, or a board with a thickness in the range of 10 mm to 30 mm) may be less than ±5%. Thickness non-uniformity for a particular article, across the article, (eg. a 18 mm thick board, or a board with a thickness in the range of 10 mm to 30 mm) may be less than ±2.5%. Thickness uniformity is aided by depositing material uniformly in the moulds. More uniform thickness properties provide more reliable plastic article material strength across the article.

As an alternative to the oil heating of FIG. 5, a mould part may be heated using the circulation of some other fluid, or electrical heating, or microwave heating, for example.

II. Method of Manufacturing Plastic Article (eg. a Board) with at Least One Extra Outer Skin

There is provided a method of manufacturing a plastic article (eg. a board) with at least one extra outer skin with respect to methods described above. Aspects of the manufacturing methods disclosed herein may be employed in the method of manufacturing a plastic article with at least one extra outer skin.

An example of a method of manufacturing a plastic article with at least one extra outer skin will now be described. A manufacturing process is provided for forming plastic into a predetermined shape from a plastic particulate material, and a heat-activated expandable foam plastic filler material, and a first outer skin material and a second outer skin material, the process comprising the steps of:

(i) providing first and second complementary mould parts, the mould parts being formed into a predetermined shape with at least a face portion on each of said complementary first and second mould parts to impart a desired shape;

(ii) heating said first and second mould parts at least on their face portions to an elevated temperature of from about 100° C. to about 500° C. such that the mould parts are at a temperature to make the plastic particulate material molten or sinterable and the first outer skin material and the second outer skin material molten or sinterable;

(iii) contacting the first and second mould parts respectively with the first outer skin and the second outer skin materials;

(iv) contacting at least one of the first outer skin and the second outer skin materials with plastic particulate material;

(v) contacting the heat-activated expandable foam plastic filler material to the plastic particulate or an outer skin material on a face portion of at least one of the two complementary heated mould parts;

(vi) melting or sintering at least a portion of the first outer skin material and the second outer skin material on each respective mould part into a moulded skin of a plastic article having a skin of a desired thickness of from about 0.001 cm to about 3.0 cm;

(vii) melting or sintering at least a portion of the plastic particulate material into an inner skin of a plastic article having a skin of a desired thickness of from about 0.001 cm to about 3.0 cm;

(viii) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

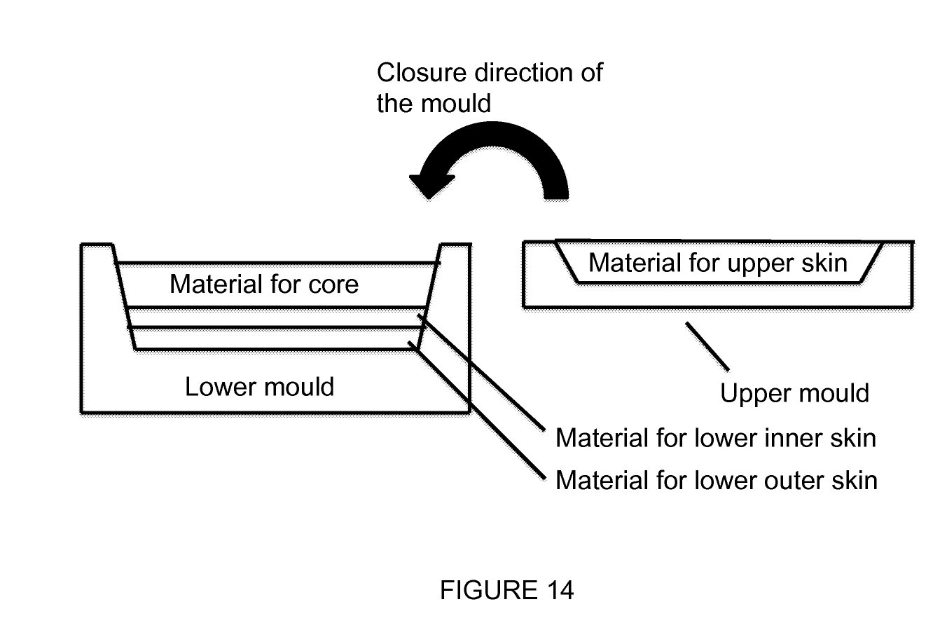

An example of: contacting the first and second mould parts respectively with first outer skin and second outer skin materials; contacting at least one of the first outer skin and the second outer skin materials with plastic particulate material, and contacting the heat-activated expandable foam plastic filler material to the plastic particulate or an outer skin material on a face portion of at least one of the two complementary heated mould parts is shown in FIG. 14. In the example of FIG. 14, the first outer skin material is the material for the lower outer skin, the second outer skin material is the material for the upper skin, the plastic particulate material is the material for the lower inner skin, and the heat-activated expandable foam plastic filler material is the material for the core.

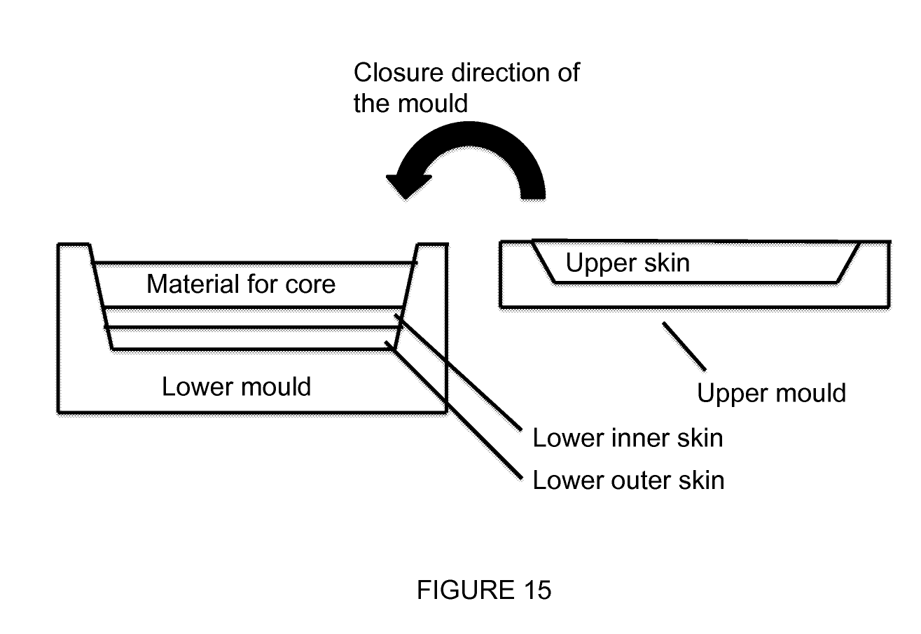

An example of: melting or sintering at least a portion of the first outer skin material and the second outer skin material on each respective mould part into a moulded skin of a plastic article having a skin of a desired thickness of from about 0.001 cm to about 3.0 cm, and melting or sintering at least a portion of the plastic particulate material into an inner skin of a plastic article having a skin of a desired thickness of from about 0.001 cm to about 3.0 cm, is shown in FIG. 15. In the example of FIG. 15, the first outer skin is the lower outer skin, the second outer skin is the upper skin, and the inner skin is the lower inner skin.

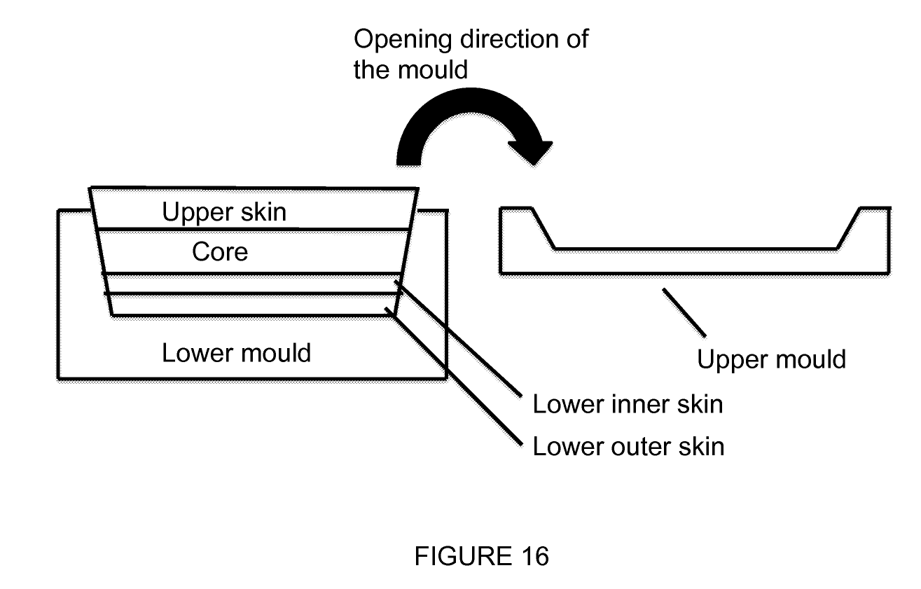

An example of cooling the mould parts in an open configuration to a mould starting temperature, which permits removal from the lower mould of a plastic article with at least one extra outer skin is shown in FIG. 16.

The plastic particulate material may include fibres. An outer skin material may include fibres. An outer skin material may comprise an outer plastic particulate material layer and an inner fibre mat layer. An outer skin material may comprise an outer fibre mat layer and an inner plastic particulate material layer. Both the first outer skin material and the second outer skin material may includes fibres. Fibres may be included between the plastic particulate material and an outer skin material to which plastic particulate material is contacted in step (iv) of the example method of manufacturing a plastic article with at least one extra outer skin. Fibres may be included between the heat-activated expandable foam plastic filler material and the material to which heat-activated expandable foam plastic filler material is contacted in step (v) of the example method of manufacturing a plastic article with at least one extra outer skin. The fibres may be glass, carbon, cellulose, metal, polymer, hemp, hessian or organic. The fibres may be short. The short fibres may be 10 mm or less in length. The fibres may be chopped-down. The fibres may be long. The long fibres may be greater than 10 mm in length. The fibres may be continuous. The continuous fibres may extend across the article. The fibres may be provided in a mat or mesh, or woven. The fibres may include polymer fibres and non-polymer fibres. The polymer fibres may melt during the process and non-polymer fibres may not melt during the process. Melting of polymer fibres and solidification of melted polymer fibre material may improve the bonding of non-polymer fibres to the rest of the article. The fibres may be included loose. The fibres may be included in a multi-directional manner eg. woven or random. The fibres may be included in a uni-directional or bi-directional manner, eg. orthogonal. The fibres may be provided in a mat that is rolled off a roll in detachable sheets for detachment and for insertion into the mould parts. The fibres may be provided in a mat that is lifted off a stack of fibre mat sheets for insertion into the mould. Two fibre mats may be provided, arranged on opposite sides of the article. Exactly two fibre mats may be provided, arranged on opposite sides of the article. Exactly one fibre mat may be provided for the whole article.

Fibres or fibre mats may increase the stiffness of an article, they may reduce thermal movement within an article, and they may increase energy absorption by the article. Fibres or fibre mats may improve the fracture resistance or tearing resistance of an article.

In the example method of manufacturing a plastic article with at least one extra outer skin, in step (iv), both the first outer skin and the second outer skin materials may be contacted with plastic particulate material.

An outer skin may provide one or more of: added strength, a selected colour, an odor, a deodor, fire resistance, UV stabilizers, ready-releasable properties, eg. for forming applications, or a smooth surface finish, eg fewer or no surface pits due to contaminants in the recycled plastics.

A computer program product is provided for running on a computer, wherein the computer program product running on a computer is operable to control a method of manufacturing a plastic article with at least one extra outer skin.

A plastic article is provided which is produced using a method of manufacturing a plastic article with at least one extra outer skin. The following alternatives are provided. The plastic article may be such that the article presents in cross-section a layered structure comprising: first outer skin, fibres, inner skin, core, inner skin, fibres, second outer skin. The plastic article may be such that the article presents in cross-section a layered structure comprising: first outer skin, fibres, inner skin, core, inner skin, second outer skin. The plastic article may be such that the article presents in cross-section a layered structure comprising: first outer skin, inner skin, fibres, core, fibres, inner skin, second outer skin. The plastic article may be such that the article presents in cross-section a layered structure comprising: first outer skin, inner skin, fibres, core, inner skin, second outer skin. The plastic article may be such that the article presents in cross-section a layered structure comprising: first outer skin, inner skin, fibres, core, inner skin, fibres, second outer skin.

III. Method of Manufacturing a Plastic Article with a Rapid Manufacturing Cycle Time

There is provided a method of manufacturing a plastic article with a rapid manufacturing cycle time. Aspects of the manufacturing methods disclosed herein may be employed in the method of manufacturing a plastic article with a rapid manufacturing cycle time.

An example of a method of manufacturing a plastic article with a rapid manufacturing cycle time will now be described. A manufacturing cycle process is provided for forming plastic into a predetermined shape from a plastic particulate material, and a heat-activated expandable foam plastic filler material, using manufacturing apparatus, the apparatus including first and second complementary mould parts, the mould parts being formed into a predetermined shape with at least a face portion on each of said complementary first and second mould parts to impart a desired shape;

wherein the manufacturing cycle comprises

(i) starting with the mould parts in an open configuration, at a mould starting temperature between room temperature and about 100° C.;

(ii) moving the mould parts into a brought-together configuration,

(iii) heating said first and second mould parts at least on their face portions to an elevated temperature of from about 100° C. to about 400° C. such that the mould parts are at a temperature to make the plastic particulate material molten or sinterable;

(iv) opening the mould parts into an open configuration while actively heating the mould parts;

(v) contacting the first and second mould parts with plastic particulate material;

(vi) contacting the heat-activated expandable foam plastic filler material to the plastic particulate material on a face portion of at least one of the two complementary heated mould parts;

(vii) melting or sintering at least a portion of the plastic particulate material on each mould part into a moulded skin of a plastic article having a skin of a desired thickness of from about 0.001 cm to about 3.0 cm;

(viii) bringing together the complementary face portions of the heated first and second mould parts whereby the heat from the heated mould parts will activate the heat-activated expandable foam plastic filler material to cause it to form a composite sandwich such that an article is formed having a moulded surface on both sides;

(ix) opening the mould parts into an open configuration;

(x) cooling the mould parts to the mould starting temperature, and

(xi) removing the plastic article from the mould, wherein the manufacturing cycle time is less than 90 minutes.

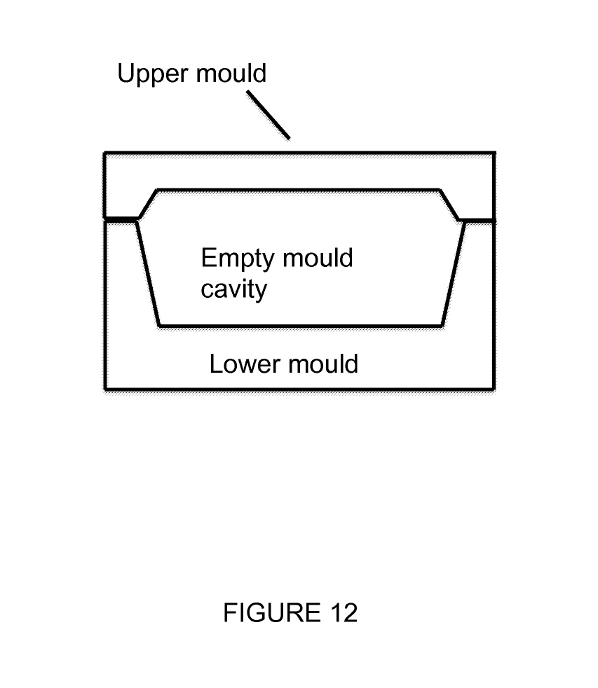

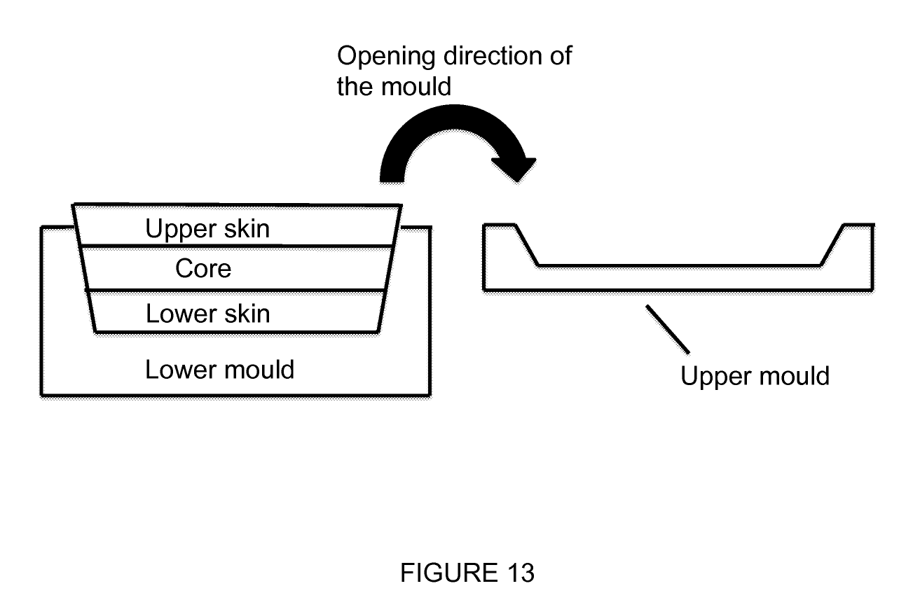

An example of heating upper and lower mould parts in a brought-together configuration in step (iii) is shown in FIG. 12. An example of cooling the mould parts in step (x) in an open configuration to the mould starting temperature is shown in FIG. 13.

The manufacturing cycle time may be less than 60 minutes. The manufacturing cycle time may be less than 50 minutes. The manufacturing cycle time may be less than 40 minutes. The manufacturing cycle time may be less than 30 minutes. The manufacturing cycle time may be less than 20 minutes. A shorter manufacturing time provides greater throughput. The manufacturing cycle time may be greater than 5 minutes. The manufacturing cycle time may be greater than 10 minutes. The manufacturing cycle time may be greater than 20 minutes. A longer manufacturing time provides reduced thermal stresses in the product, because a more uniform temperature distribution is provided.

In the manufacturing cycle, the starting temperature in step (i) may be between 40° C. and 80° C. In the manufacturing cycle, the starting temperature in step (i) may be between 50° C. and 70° C. In the manufacturing cycle, at the end of step (xi), remaining oozed-out material may be scraped off the edge of the mould. Between steps (viii) and (ix), the mould may be cooled to a temperature greater than the starting temperature.

There is further provided a computer program product for running on a computer, wherein the computer program product running on a computer is operable to control a manufacturing cycle process as described herein.

There is provided an aggregate manufacturing cycle process using manufacturing apparatus which includes a plurality of moulds comprising a plurality of sets of moulds, with the manufacturing cycle time being in common for each mould. An aggregate process provides for greater manufacturing throughput. Each mould may be used to perform a manufacturing cycle process as described herein. In an example, one set of moulds can start its manufacturing cycle process when another set of moulds is half way through its manufacturing cycle process. This way one set of moulds can be emptied of their moulded articles, and prepared with materials for moulding the next articles, while the other set of moulds is about mid-way through its manufacturing cycle process. This provides for a more efficient use of mould emptying and filling equipment and/or labour than if all moulds were operated with a common cycle time and with no difference between their cycle starting times. Examples of mould emptying equipment includes robotic arms for grabbing the moulded articles, or pneumatic suction cups for pneumatic suction attachment to a top surface of a moulded article for lifting the moulded article. An example of mould filling equipment includes a hopper disposed above the moulds, and moveable across the plurality of moulds so as to be able to drop materials for moulding the next articles into the open moulds under the force of gravity. Another example of mould filling equipment is a dispenser arranged to scatter materials for moulding the next articles into the open moulds.

An example aggregate manufacturing cycle process uses manufacturing apparatus, the manufacturing apparatus including moulds comprising a plurality of sets of moulds, wherein each mould is used to perform a manufacturing cycle process as described herein, wherein the manufacturing cycle time is common to each mould, wherein a first set of moulds is used to perform a manufacturing cycle process as described herein, and a second set of moulds is used to perform a manufacturing cycle process as described herein, wherein a starting time of the cycle of the first set of moulds and a starting time of the cycle of the second set of moulds are different. The difference is between zero and one manufacturing cycle time.

The first set of moulds may comprise one mould. The first set of moulds may comprise at least two moulds. The second set of moulds may comprise one mould. The second set of moulds may comprise at least two moulds. The difference between the starting time of the cycle of the first set of moulds and the starting time of the cycle of the second set of moulds may be half the common cycle time.

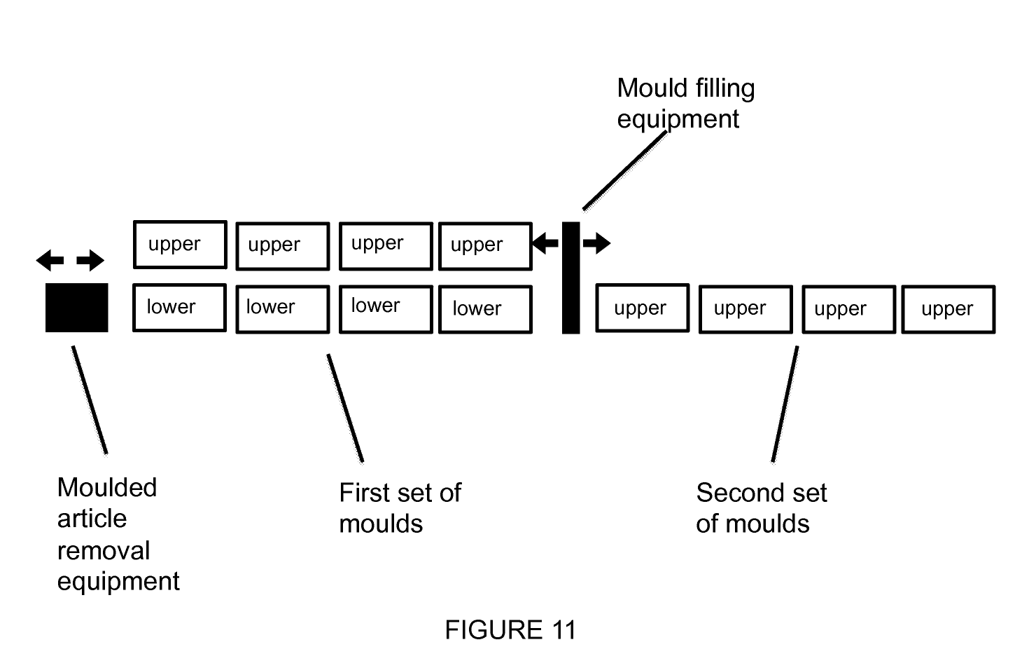

FIG. 11 shows an example of apparatus which may be used in an aggregate manufacturing cycle process, in plan view. The apparatus includes a first set of moulds which are shown in an open configuration, so that their upper parts and lower parts are visible. The apparatus includes a second set of moulds which are shown in a brought together configuration, so that only their upper parts are visible, where their upper parts have moved above their lower parts so as to bring the mould parts together. A hopper and moulded article removal equipment are shown next to the first set of moulds. In an example of step (xi) of a manufacturing cycle process the moulded article removal equipment is moved into proximity with an open mould so as to remove a moulded article from the lower mould. The moulded article removal equipment is at least laterally movable so as to be able to remove a moulded article from any lower mould part in the first and second moulds, when the mould is open. In an example of steps (v) and (vi) of a manufacturing cycle process, the hopper can drop plastic particulate material onto the mould parts of an open mould from a first hopper compartment, and the hopper can drop heat-activated expandable foam plastic filler material onto plastic particulate material on the open mould parts from a second hopper compartment. The hopper is at least laterally movable so as to be able to drop materials into any upper or lower mould part of the first and second sets of moulds, when the moulds are open. In FIG. 11, arrows indicate possible movement directions of moulded article removal equipment and of mould filling equipment. In FIG. 11, the start times of the manufacturing cycle processes of the first set of moulds and of the second set of moulds differ by half a cycle. Therefore the first set of moulds can be emptied of their moulded articles, and prepared with materials for moulding the next articles, while the second set of moulds is about mid-way through its manufacturing cycle process.

There is further provided a computer program product for running on a computer, wherein the computer program product running on a computer is operable to control an aggregate manufacturing cycle process as described herein.

### APPENDIX 1: CONCEPTS

Concepts A to G for manufacturing plastic articles are disclosed below. Aspects of the concepts may be combined. Reference may be had to WO2002/062550 and GB2460838A regarding related methods for manufacturing plastic articles.

### A. Method of Manufacturing Plastic Article eg. a Board

A process for forming plastic into a predetermined shape from a plastic particulate material, and a heat-activated expandable foam plastic filler material, the process comprising the steps of:

(i) providing first and second complementary mould parts, the mould parts being formed into a predetermined shape with at least a face portion on each of said complementary first and second mould parts to impart a desired shape;

(ii) heating said first and second mould parts at least on their face portions to an elevated temperature of from about 100° C. to about 865° C. such that the mould parts are at a temperature to make the plastic particulate material molten or sinterable;

(iii) contacting the first and second mould parts with plastic particulate material;

(iv) contacting the heat-activated expandable foam plastic filler material to the plastic particulate material on a face portion of at least one of the two complementary heated mould parts;

(v) melting or sintering at least a portion of the plastic particulate material on each mould part into a moulded skin of a plastic article having a skin of a desired thickness of from about 0.001 cm to about 3.0 cm;

(vi) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

Further features may include:
moulds made of a material selected from the group consisting of aluminium, aluminium alloys, stainless steel, kirksite, metals, ceramics, cermets, high temperature plastics, formable heat resistant materials.
plastic particulate material is recycled plastic.
recycled plastic is comingled contaminated recycled plastic.
plastic particulate material is non-recycled plastic.
non-recycled plastic is virgin polymer.
material introduced into the mould further includes elastomeric material.
material introduced into the mould further includes rubber.
heating in step (ii) is performed with the mould closed. When target temperature is reached, the mould is opened for application of plastic particulate material.
One mould part is flat, and the other mould part is hollow.
Both mould parts are hollow.
During step (vi) the mould is slightly open where the face portions meet so that the inside of the mould is at atmospheric pressure.
During step (vi) the first and second mould parts are actively heated.
During step (vi), the process does not rely on the residual heat of the mould parts.
The quantities of plastic particulate material and heat-activated expandable foam plastic filler material used are such that when those materials are fully expanded, the volume of the article is greater than the volume of the mould.
some material from the article oozes out the mould as the article is formed.
Oozing material goes into an overspill channel in the mould.
Mould parts pre-coated with release agents prior to application of plastic particulate material.
Plastic article is a board.
Board is no less than 2 feet×2 feet. (2 feet×2 feet=60.96 cm×60.96 cm).
Board is no bigger than 15 feet×10 feet. (15 feet×10 feet=457.2 cm×304.8 cm).
Board is no thicker than 200 mm.
Board is no thicker than 80 mm.
Board is no thinner than 4 mm.
Board may include inserts in the core or skin layers.
Board may include inserts on top of the skin layers or between the core and skin layers.
Board may include inserts on top of an additional plastic layer eg. an extruded layer.
Board can be stamped or branded with a mark.
Board only square or rectangular.
In step (iii), the plastic particulate material before contacting is at least at room temperature.
During step (vi), the mould temperature is at a maximum at a place not near to the edge of the mould, and the mould temperature decreases between that place and the edge of the mould.
During step (vi), the mould temperature is at a maximum at or near to the centre of the mould, and the mould temperature decreases between that place and the edge of the mould.
Maximum temperature in step (ii) is 500° C.
Maximum temperature in step (ii) is 400° C.
Maximum temperature in step (ii) is 300° C.
Maximum temperature in step (ii) is 260° C.
Maximum temperature in step (ii) is 250° C.
Maximum temperature in step (ii) is 200° C.
In step (ii), entire mould parts are heated.
plastic particulate material includes a blend of plastics.
the blend of plastics is derived from different input streams.
heat-activated expandable foam plastic filler material includes heat-activated expandable foamable plastic filler material.
plastic particulate material and heat-activated expandable foam plastic filler material are dropped onto the mould parts under the force of gravity.
during step (vi), a mould part covered only in skin is turned upside-down above the other mould part, wherein the skin is sufficiently adherent not to detach from the upside-down mould part, and the skin is sufficiently viscous not to deform appreciably under gravity.
during step (vi), during core foaming, the core bonds to the skins.
during step (vi) the mould is slightly open where the face portions meet so that the inside of the mould is in communication with atmospheric pressure.
during step (vi) the mould is first closed, wherein foaming of the core causes a pressure-induced leakage from the mould above a threshold pressure.
the threshold pressure is in the range 0.5 bar to 5 bar in excess of atmospheric pressure.
the process is a manufacturing process tolerant to the compositions of the plastic particulate material and the heat-activated expandable foam plastic filler material.
the process includes a step in which the article is removed from the mould, the process including a further finishing step wherein the article removed from the mould is trimmed around its edges to provide an article with more neatly finished edges.
waste material from the finishing step is recycled into the manufacturing process.
the temperature of the mould parts is increased or decreased as required during the manufacturing process by flowing temperature-controlled oil through channels in the mould parts.
the channels are arranged in the mould parts to achieve a higher temperature near to the centre of the mould and a lower temperature at a mould edge.
mould parts are pre-coated with one or more coatings prior to application of plastic particulate material.
during step (vi) a foaming process begins near the mould centre, and spreads out to a mould edge.
the moulds are made of nickel alloys material.

There is further provided a plastic article produced using a process of concept A.

There is further provided a computer program product for running on a computer, wherein the computer program product running on a computer is operable to control a process of concept A.

B. Method of Manufacturing Plastic Article (eg. a Board) with at Least One Extra Outer Skin

A process for forming plastic into a predetermined shape from a plastic particulate material, and a heat-activated expandable foam plastic filler material, and a first outer skin material and a second outer skin material, the process comprising the steps of:

(i) providing first and second complementary mould parts, the mould parts being formed into a predetermined shape with at least a face portion on each of said complementary first and second mould parts to impart a desired shape;

(ii) heating said first and second mould parts at least on their face portions to an elevated temperature of from about 100° C. to about 865° C. such that the mould parts are at a temperature to make the plastic particulate material molten or sinterable and the first outer skin material and the second outer skin material molten or sinterable;

(iii) contacting the first and second mould parts respectively with the first outer skin and the second outer skin materials;

(iv) contacting at least one of the first outer skin and the second outer skin materials with plastic particulate material;

(v) contacting the heat-activated expandable foam plastic filler material to the plastic particulate or an outer skin material on a face portion of at least one of the two complementary heated mould parts;

(vi) melting or sintering at least a portion of the first outer skin material and the second outer skin material on each respective mould part into a moulded skin of a plastic article having a skin of a desired thickness of from about 0.001 cm to about 3.0 cm;

(vii) melting or sintering at least a portion of the plastic particulate material into an inner skin of a plastic article having a skin of a desired thickness of from about 0.001 cm to about 3.0 cm;

(viii) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

Further features may include:
moulds made of a material selected from the group consisting of aluminium, aluminium alloys, stainless steel, kirksite, metals, ceramics, cermets, high temperature plastics, formable heat resistant materials.
plastic particulate material is recycled plastic.
recycled plastic is comingled contaminated recycled plastic.
plastic particulate material is non-recycled plastic.
non-recycled plastic is virgin polymer.
material introduced into the mould further includes elastomeric material.
material introduced into the mould further includes rubber.
heating in step (ii) is performed with the mould closed. When target temperature is reached, the mould is opened for application of the outer skin materials and plastic particulate material.
One mould part is flat, and the other mould part is hollow.
Both mould parts are hollow.
During step (viii) the mould is slightly open where the face portions meet so that the inside of the mould is at atmospheric pressure.
During step (viii) the first and second mould parts are actively heated.
During step (viii), the process does not rely on the residual heat of the mould parts.
in step (iv), both the first outer skin and the second outer skin materials are contacted with plastic particulate material.
The quantities of outer skin materials, plastic particulate material and heat-activated expandable foam plastic filler material used are such that when those materials are fully expanded, the volume of the article is greater than the volume of the mould.
some material from the article oozes out the mould as the article is formed.
Oozing material goes into an overspill channel in the mould.
Mould parts pre-coated with release agents prior to application of materials for forming plastic article.
Outer skin provides at least one of: added strength, selected colour, odor, deodor, fire resistance, UV stabilizers, ready-releasable properties (eg. for forming applications), a smooth surface finish (eg fewer or no surface pits due to contaminants in the recycled plastics).
During step (iv), the plastic particulate material before contacting is at least at room temperature.
Plastic article is a board.
Board is no less than 2 feet×2 feet. (2 feet×2 feet=60.96 cm×60.96 cm).
Board is no bigger than 15 feet×10 feet. (15 feet×10 feet=457.2 cm×304.8 cm).
Board is no thicker than 200 mm.
Board is no thicker than 80 mm.
Board is no thinner than 4 mm.
Board may include inserts in the core or skin layers.
Board may include inserts on top of the skin layers or between the core and skin layers.
Board may include inserts on top of an additional plastic layer eg. an extruded layer.
Board can be stamped or branded with a mark.
Board only square or rectangular.
During step (viii), the mould temperature is at a maximum at a place not near to the edge of the mould, and the mould temperature decreases between that place and the edge of the mould.
During step (viii), the mould temperature is at a maximum at or near to the centre of the mould, and the mould temperature decreases between that place and the edge of the mould.
Maximum temperature in step (ii) is 500° C.
Maximum temperature in step (ii) is 400° C.
Maximum temperature in step (ii) is 300° C.
Maximum temperature in step (ii) is 260° C.
Maximum temperature in step (ii) is 250° C.
Maximum temperature in step (ii) is 200° C.
In step (ii), entire mould parts are heated.
the plastic particulate material includes fibres.
Inner skin material includes fibres.
Outer skin material includes fibres.
the outer skin material comprises an outer plastic particulate material layer and an inner fibre mat layer.
the outer skin material comprises an outer fibre mat layer and an inner plastic particulate material layer.
the first outer skin material includes fibres and the second outer skin material includes fibres.
fibres are included between the plastic particulate material and an outer skin material to which plastic particulate material is contacted in step (iv).
fibres are included between the heat-activated expandable foam plastic filler material and the material to which heat-activated expandable foam plastic filler material is contacted in step (v).
Fibres are included between the inner and outer skins.
Fibres are included between the core and a skin.
fibres are glass, carbon, cellulose, metal, polymer, hemp, hessian or organic.
Fibres are short.
Short fibres are 10 mm or less in length.
fibres are chopped-down.
Fibres are long.
Long fibres are greater than 10 mm in length.
Fibres are continuous.
Continuous fibres extend across the article.
Fibres are provided in a mat or mesh, or woven.
fibres include polymer fibres and non-polymer fibres.
polymer fibres melt during the process and non-polymer fibres do not melt during the process.
Fibres are included loose.
Fibres are included in a multi-directional manner eg. woven or random.
Fibres are included in a uni-directional manner.
fibres are included in a bi-directional manner.
fibres are provided in a mat that is rolled off a roll in detachable sheets for detachment and for insertion into the mould parts.
fibres are provided in a mat that is lifted off a stack of fibre mat sheets for insertion into the mould.
wherein two fibre mats are provided, arranged on opposite sides of the article.
exactly two fibre mats are provided, arranged on opposite sides of the article.
exactly one fibre mat is provided for the whole article.
the plastic particulate material includes a blend of plastics.
the blend of plastics is derived from different input streams.
the heat-activated expandable foam plastic filler material includes heat-activated expandable foamable plastic filler material.
plastic particulate material and heat-activated expandable foam plastic filler material are dropped onto the mould parts under the force of gravity.
during step (viii), a mould part covered only in skin is turned upside-down above the other mould part, wherein the skin is sufficiently adherent not to detach from the upside-down mould part, and the skin is sufficiently viscous not to deform appreciably under gravity.
during step (viii), during core foaming, the core bonds to the skins.
during step (viii) the mould is slightly open where the face portions meet so that the inside of the mould is in communication with atmospheric pressure.
during step (viii) the mould is first closed, wherein foaming of the core causes a pressure-induced leakage from the mould above a threshold pressure.
the threshold pressure is in the range 0.5 bar to 5 bar in excess of atmospheric pressure.
the process is a manufacturing process tolerant to the compositions of the plastic particulate material and the heat-activated expandable foam plastic filler material.
including a step in which the article is removed from the mould, the process including a further finishing step wherein the article removed from the mould is trimmed around its edges to provide an article with more neatly finished edges.
waste material from the finishing step is recycled into the manufacturing process.
the temperature of the mould parts is increased or decreased as required during the manufacturing process by flowing temperature-controlled oil through channels in the mould parts.
the channels are arranged in the mould parts to achieve a higher temperature near to the centre of the mould and a lower temperature at a mould edge.
during step (viii) a foaming process begins near the mould centre, and spreads out to a mould edge.
mould parts are pre-coated with one or more coatings prior to application of plastic particulate material.
the moulds are made of nickel alloys material.

There is further provided a computer program product for running on a computer, wherein the computer program product running on a computer is operable to control a process of concept B.

Plastic article produced using a process of concept B.

A plastic article wherein the article presents in cross-section a layered structure comprising: a first outer skin, an inner skin, a core, an inner skin, and a second outer skin.

The above plastic article wherein the article presents in cross-section a layered structure comprising: a first outer skin, fibres, an inner skin, a core, an inner skin, fibres, and a second outer skin.

The above plastic article, wherein the article presents in cross-section a layered structure comprising: a first outer skin, fibres, an inner skin, a core, an inner skin, and a second outer skin.

The above plastic article, wherein the article presents in cross-section a layered structure comprising: a first outer skin, an inner skin, fibres, a core, fibres, an inner skin, and a second outer skin.

The above plastic article, wherein the article presents in cross-section a layered structure comprising: a first outer skin, an inner skin, fibres, a core, an inner skin, and a second outer skin.

The above plastic article, wherein the article presents in cross-section a layered structure comprising: a first outer skin, an inner skin, fibres, a core, an inner skin, fibres, and a second outer skin.

Plastic article board comprising recycled plastic, the board comprising a first outer skin, an inner skin, a core, an inner skin, and a second outer skin, the core bonded to the inner skin layers, the board having an area no less than 2 feet×2 feet, and no greater than 15 feet×10 feet, wherein the board is no thicker than 200 mm and no thinner than 4 mm, wherein the board thickness non-uniformity across the board is less than ±5%.

The board may be one wherein the board thickness non-uniformity across the board is less than ±2.5%.

The board may be one wherein the board is no thicker than 80 mm.

The board may be one wherein the board thickness is in the range of 10 mm to 30 mm.

The board may be one wherein the recycled plastic is comingled contaminated recycled plastic.

The field of this concept relates to methods for forming plastic into a predetermined shape. A process is provided for forming plastic into a predetermined shape from a plastic particulate material, and a heat-activated expandable foam plastic filler material, and first and second outer skin materials, comprising the steps of:

(i) providing first and second complementary mould parts;

(ii) heating said first and second mould parts at least on their face portions such that the mould parts are at a temperature to make the plastic particulate material and the outer skin materials molten or sinterable;

(iii) contacting the first and second mould parts with outer skin materials;

(iv) contacting at least one of the outer skin materials with plastic particulate material;

(v) contacting the heat-activated expandable foam plastic filler material to the plastic particulate material or an outer skin material;

(vi) melting or sintering at least a portion of the outer skin materials and the plastic particulate material on each mould part into a moulded skin;

(vii) bringing together the complementary face portions of the heated first and second mould parts to form a composite sandwich.

C. Method of Manufacturing Plastic Article (eg. a Board) with at Least One Extra Outer Extruded Skin

A process for forming plastic into a predetermined shape from a plastic particulate material, an extruded plastic skin material and a heat-activated expandable foam plastic filler material, the process comprising the steps of:

(i) providing first and second complementary mould parts, the mould parts being formed into a predetermined shape with at least a face portion on each of said complementary first and second mould parts to impart a desired shape;

(ii) heating said first and second mould parts at least on their face portions to an elevated temperature of from about 100° C. to about 865° C. such that the mould parts are at a temperature to make the plastic particulate material molten or sinterable;

(iii) contacting at least one of the first and second mould parts with extruded plastic skin material;

(iv) contacting the extruded skin material with plastic particulate material, and where a mould part is not in contact with the extruded plastic skin material, contacting the mould part with plastic particulate material;

(v) contacting the heat-activated expandable foam plastic filler material to the plastic particulate material on a face portion of at least one of the two complementary heated mould parts;

(vi) melting or sintering at least a portion of the plastic particulate material into a skin of a plastic article having a skin of a desired thickness of from about 0.001 cm to about 3.0 cm;

(vii) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

Further features may include:
moulds made of a material selected from the group consisting of aluminium, aluminium alloys, stainless steel, kirksite, metals, ceramics, cermets, high temperature plastics, formable heat resistant materials.
plastic particulate material is recycled plastic.
recycled plastic is comingled contaminated recycled plastic.
plastic particulate material is non-recycled plastic.
non-recycled plastic is virgin polymer.
material introduced into the mould further includes elastomeric material.
material introduced into the mould further includes rubber.
heating in step (ii) is performed with the mould closed. When target temperature is reached, the mould is opened for application of the extruded skin material and plastic particulate material.
One mould part is flat, and the other mould part is hollow.
Both mould parts are hollow.
During step (vii) the mould is slightly open where the face portions meet so that the inside of the mould is at atmospheric pressure.
During step (vii) the first and second mould parts are actively heated.
During step (vii), the process does not rely on the residual heat of the mould parts.
The quantities of extruded skin materials, plastic particulate material and heat-activated expandable foam plastic filler material used are such that when those materials are fully expanded, the volume of the article is greater than the volume of the mould.
some material from the article oozes out the mould as the article is formed.
Oozing material goes into an overspill channel in the mould.
Mould parts pre-coated with release agents prior to application of materials for forming plastic article.
Extruded skin provides at least one of: added strength, selected colour, odor, deodor, fire resistance, UV stabilizers, ready-releasable properties (eg. for forming applications), a smooth surface finish (eg fewer or no surface pits due to contaminants in the recycled plastics).
During step (iv), the plastic particulate material before contacting is at least at room temperature.
Plastic article is a board.
Board is no less than 2 feet×2 feet. (2 feet×2 feet=60.96 cm×60.96 cm).
Board is no bigger than 15 feet×10 feet. (15 feet×10 feet=457.2 cm×304.8 cm).
Board is no thicker than 200 mm.
Board is no thicker than 80 mm.
Board is no thinner than 4 mm.
Board may include inserts in the core or skin layers.
Board may include inserts on top of the skin layers or between the core and skin layers.
Board may include inserts on top of an additional plastic layer eg. an extruded layer.
Board can be stamped or branded with a mark.
Board only square or rectangular.
During step (vii), the mould temperature is at a maximum at a place not near to the edge of the mould, and the mould temperature decreases between that place and the edge of the mould.
During step (vii), the mould temperature is at a maximum at or near to the centre of the mould, and the mould temperature decreases between that place and the edge of the mould.
Maximum temperature in step (ii) is 500° C.
Maximum temperature in step (ii) is 400° C.
Maximum temperature in step (ii) is 300° C.
Maximum temperature in step (ii) is 260° C.
Maximum temperature in step (ii) is 250° C.
Maximum temperature in step (ii) is 200° C.
In step (ii), entire mould parts are heated.
Non-extruded skin includes fibres.
Extruded skin includes fibres.
Fibres are included between the non-extruded and extruded skins.
Fibres are included between the core and a non-extruded skin.
Fibres are glass, carbon, cellulose, metal or polymer.
Fibres are short.
Short fibres are 10 mm or less in length.
Fibres are long.
Long fibres are greater than 10 mm in length.
Fibres are continuous.
Continuous fibres extend across the article.
Fibres are in a mat or mesh, or woven.
Fibres are included loose.
Fibres are included in a multi-directional manner eg. woven or random.
Fibres are included in a uni-directional manner.
   D. Method of Manufacturing a Plastic Article with a Rapid Manufacturing Cycle Time

A manufacturing cycle process for forming plastic into a predetermined shape from a plastic particulate material, and a heat-activated expandable foam plastic filler material, using manufacturing apparatus, the apparatus including a mould comprising first and second complementary mould parts, the mould parts being formed into a predetermined shape with at least a face portion on each of said complementary first and second mould parts to impart a desired shape;

wherein the manufacturing cycle comprises

(i) starting with the mould parts in an open configuration, at a mould starting temperature between room temperature and about 100° C.;

(ii) moving the mould parts into a brought-together configuration,

(iii) heating said first and second mould parts at least on their face portions to an elevated temperature of from about 100° C. to about 400° C. such that the mould parts are at a temperature to make the plastic particulate material molten or sinterable;

(iv) opening the mould parts into an open configuration while actively heating the mould parts;

(v) contacting the first and second mould parts with plastic particulate material;

(vi) contacting the heat-activated expandable foam plastic filler material to the plastic particulate material on a face portion of at least one of the two complementary heated mould parts;

(vii) melting or sintering at least a portion of the plastic particulate material on each mould part into a moulded skin of a plastic article having a skin of a desired thickness of from about 0.001 cm to about 3.0 cm;

(viii) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

(ix) opening the mould parts into an open configuration;

(x) cooling the mould parts to the mould starting temperature, and

(xi) removing the plastic article from the mould wherein a manufacturing cycle time is less than 90 minutes.

Further features may include:
manufacturing cycle time is less than 60 minutes.
manufacturing cycle time is less than 50 minutes.
manufacturing cycle time is less than 40 minutes.
manufacturing cycle time is less than 30 minutes.
manufacturing cycle time is less than or equal to 20 minutes.
manufacturing cycle time is greater than 5 minutes.
manufacturing cycle time is greater than 10 minutes.
manufacturing cycle time is greater than or equal to 20 minutes.
moulds made of a material selected from the group consisting of aluminium, aluminium alloys, stainless steel, kirksite, metals, ceramics, cermets, high temperature plastics, formable heat resistant materials.
plastic particulate material is recycled plastic.
recycled plastic is comingled contaminated recycled plastic.
plastic particulate material is non-recycled plastic.
non-recycled plastic is virgin polymer.
material introduced into the mould further includes elastomeric material.
material introduced into the mould further includes rubber.
One mould part is flat, and the other mould part is hollow.
Both mould parts are hollow.
During step (viii) the mould is slightly open where the face portions meet so that the inside of the mould is at atmospheric pressure.
During step (viii) the first and second mould parts are actively heated.
During step (viii), the process does not rely on the residual heat of the mould parts.
The quantities of plastic particulate material and heat-activated expandable foam plastic filler material used are such that when those materials are fully expanded, the volume of the article is greater than the volume of the mould.
some material from the article oozes out the mould as the article is formed.
Oozing material goes into an overspill channel in the mould.
Mould parts coated in step (i) with release agents prior to application of plastic particulate material in step (v).
Plastic article is a board.
Board is no less than 2 feet×2 feet. (2 feet×2 feet=60.96 cm×60.96 cm).
Board is no bigger than 15 feet×10 feet. (15 feet×10 feet=457.2 cm×304.8 cm).
Board is no thicker than 200 mm.
Board is no thicker than 80 mm.
Board is no thinner than 4 mm.
Board may include inserts in the core or skin layers.
Board may include inserts on top of the skin layers or between the core and skin layers.
Board may include inserts on top of an additional plastic layer eg. an extruded layer.
Board can be stamped or branded with a mark.
Board only square or rectangular.
In step (v), the plastic particulate material before contacting is at least at room temperature.
During step (viii), the mould temperature is at a maximum at a place not near to the edge of the mould, and the mould temperature decreases between that place and the edge of the mould.
During step (viii), the mould temperature is at a maximum at or near to the centre of the mould, and the mould temperature decreases between that place and the edge of the mould.
Maximum temperature in step (iii) is 300° C.
Maximum temperature in step (iii) is 260° C.
Maximum temperature in step (iii) is 250° C.
Maximum temperature in step (iii) is 200° C.
Starting temperature in step (i) is between 40° C. and 80° C.
Starting temperature in step (i) is between 50° C. and 70° C.
At the end of step (xi), remaining oozed-out material is scraped off the edge of the mould.
After step (xi), the article is finished by cutting it into a standard shape eg. a rectangle.
In step (iii), entire mould parts are heated.
the plastic particulate material includes a blend of plastics.
the blend of plastics is derived from different input streams.
the heat-activated expandable foam plastic filler material includes heat-activated expandable foamable plastic filler material.
plastic particulate material and heat-activated expandable foam plastic filler material are dropped onto the mould parts under the force of gravity.
during step (viii), a mould part covered only in skin is turned upside-down above the other mould part, wherein the skin is sufficiently adherent not to detach from the upside-down mould part, and the skin is sufficiently viscous not to deform appreciably under gravity.
during step (viii), during core foaming, the core bonds to the skins.
during step (viii) the mould is slightly open where the face portions meet so that the inside of the mould is in communication with atmospheric pressure.
during step (viii) the mould is first closed, wherein foaming of the core causes a pressure-induced leakage from the mould above a threshold pressure.
the threshold pressure is in the range 0.5 bar to 5 bar in excess of atmospheric pressure.
the process is a manufacturing process tolerant to the compositions of the plastic particulate material and the heat-activated expandable foam plastic filler material.
the process including a further finishing step wherein the article removed from the mould is trimmed around its edges to provide an article with more neatly finished edges.
waste material from the finishing step is recycled into the manufacturing process.
the temperature of the mould parts is increased or decreased as required during the manufacturing process by flowing temperature-controlled oil through channels in the mould parts.
the channels are arranged in the mould parts to achieve a higher temperature near to the centre of the mould and a lower temperature at a mould edge.
during step (viii) a foaming process begins near the mould centre, and spreads out to a mould edge.
mould parts are pre-coated with one or more coatings prior to application of plastic particulate material.
moulds are made of nickel alloys material.
including a step wherein between steps (viii) and (ix), the mould is cooled to a temperature greater than the starting temperature.

There is further provided a computer program product for running on a computer, wherein the computer program product running on a computer is operable to control a process of any of the above statements according to concept D.

Plastic article produced using a process of concept D.

There is provided an aggregate manufacturing cycle process using manufacturing apparatus, the manufacturing apparatus including moulds comprising a plurality of sets of moulds, wherein each mould is used to perform a manufacturing cycle process of any of the above statements according to concept D, wherein the manufacturing cycle time is common to each mould, wherein a first set of moulds is used to perform a manufacturing cycle process of any of the above statements according to concept D, and a second set of moulds is used to perform a manufacturing cycle process of any of the above statements according to concept D, wherein a starting time of the cycle of the first set of moulds and a starting time of the cycle of the second set of moulds are different.

The aggregate manufacturing cycle may be one wherein:
the first set of moulds comprises one mould.
the first set of moulds comprises at least two moulds.
the second set of moulds comprises one mould.
the second set of moulds comprises at least two moulds.
the difference between the starting time of the cycle of the first set of moulds and the starting time of the cycle of the second set of moulds is half the common cycle time.

There is further provided a computer program product for running on a computer, wherein the computer program product running on a computer is operable to control an aggregate manufacturing cycle process of concept D.

The field of concept D relates to methods for forming plastic into a predetermined shape, to products manufactured using such methods, and to computer program products operable to run on a computer to control such methods. There is provided a manufacturing cycle process in which a mould is closed during heating so as to increase heating rate and to reduce heat losses. The mould is opened for application of materials for forming a plastic article, then closed to allow the plastic article to form. The mould is opened to increase the cooling rate. The plastic article is removed from the mould. The manufacturing cycle process reduces manufacturing cycle time and improves energy efficiency.

E. Method of Manufacturing Plastic Article Eg. A Board, with Time-Efficient Deposition of Component Materials

A process for forming plastic into a predetermined shape from a plastic particulate material, and a heat-activated expandable foam plastic filler material, the process comprising the steps of:

(i) providing first and second complementary mould parts, the mould parts being formed into a predetermined shape with at least a face portion on each of said complementary first and second mould parts to impart a desired shape;

(ii) contacting the first and second mould parts with plastic particulate material;

(iii) contacting the heat-activated expandable foam plastic filler material to the plastic particulate material on a face portion of at least one of the two complementary heated mould parts;

(iv) heating said first and second mould parts at least on their face portions to melt or to sinter at least a portion of the plastic particulate material on each mould part into a moulded skin of a plastic article having a skin of a desired thickness;

(v) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

Further features may include:
heating said first and second mould parts at least on their face portions to an elevated temperature of from about 100° C. to about 865° C. such that the mould parts are at a temperature to make the plastic particulate material molten or sinterable.
skin of a desired thickness of from about 0.001 cm to about 3.0 cm.
step (iii) is performed essentially immediately after step (ii), to provide time-efficient deposition of component materials.
moulds made of a material selected from the group consisting of aluminium, aluminium alloys, stainless steel, kirksite, metals, ceramics, cermets, high temperature plastics, formable heat resistant materials.
plastic particulate material is recycled plastic.
recycled plastic is comingled contaminated recycled plastic.
plastic particulate material is non-recycled plastic.
non-recycled plastic is virgin polymer.
material introduced into the mould further includes elastomeric material.
material introduced into the mould further includes rubber.
heating in step (i) is performed with the mould closed. When target temperature is reached, the mould is opened for application of plastic particulate material.
One mould part is flat, and the other mould part is hollow.
Both mould parts are hollow.
During step (v) the mould is slightly open where the face portions meet so that the inside of the mould is at atmospheric pressure.
During step (v) the first and second mould parts are actively heated.
During step (v), the process does not rely on the residual heat of the mould parts.
The quantities of plastic particulate material and heat-activated expandable foam plastic filler material used are such that when those materials are fully expanded, the volume of the article is greater than the volume of the mould.
some material from the article oozes out the mould as the article is formed.
Oozing material goes into an overspill channel in the mould.
Mould parts pre-coated with release agents or one or more coatings prior to application of plastic particulate material.
Plastic article is a board.
Board is no less than 2 feet×2 feet. (2 feet×2 feet=60.96 cm×60.96 cm).
Board is no bigger than 15 feet×10 feet. (15 feet×10 feet=457.2 cm×304.8 cm).
Board is no thicker than 200 mm.
Board is no thicker than 80 mm.
Board is no thinner than 4 mm.
Board may include inserts in the core or skin layers.
Board may include inserts on top of the skin layers or between the core and skin layers.
Board may include inserts on top of an additional plastic layer eg. an extruded layer.
Board can be stamped or branded with a mark.
Board only square or rectangular.
In step (ii), the plastic particulate material before contacting is at least at room temperature.
During step (v), the mould temperature is at a maximum at a place not near to the edge of the mould, and the mould temperature decreases between that place and the edge of the mould.
During step (v), the mould temperature is at a maximum at or near to the centre of the mould, and the mould temperature decreases between that place and the edge of the mould.
Maximum temperature in step (i) is 500° C.
Maximum temperature in step (i) is 400° C.
Maximum temperature in step (i) is 300° C.
Maximum temperature in step (i) is 260° C.
Maximum temperature in step (i) is 250° C.
Maximum temperature in step (i) is 200° C.
In step (i), entire mould parts are heated.
the plastic particulate material includes a blend of plastics.
the blend of plastics is derived from different input streams.
the heat-activated expandable foam plastic filler material includes heat-activated expandable foamable plastic filler material.
plastic particulate material and heat-activated expandable foam plastic filler material are dropped onto the mould parts under the force of gravity.
during step (v), a mould part covered only in skin is turned upside-down above the other mould part, wherein the skin is sufficiently viscous not to detach from the upside-down mould part, and the skin is sufficiently viscous not to deform appreciably under gravity.
during step (v), during core foaming, the core bonds to the skins.
during step (v) the mould is slightly open where the face portions meet so that the inside of the mould is in communication with atmospheric pressure.
during step (v) the mould is first closed, wherein foaming of the core causes a pressure-induced leakage from the mould above a threshold pressure.
the threshold pressure is in the range 0.5 bar to 5 bar in excess of atmospheric pressure.
the process is a manufacturing process tolerant to the compositions of the plastic particulate material and the heat-activated expandable foam plastic filler material.
the process includes a step in which the article is removed from the mould, the process including a further finishing step wherein the article removed from the mould is trimmed around its edges to provide an article with more neatly finished edges.
waste material from the finishing step is recycled into the manufacturing process.
the temperature of the mould parts is increased or decreased as required during the manufacturing process by flowing temperature-controlled oil through channels in the mould parts.
the channels are arranged in the mould parts to achieve a higher temperature near to the centre of the mould and a lower temperature at a mould edge.
during step (v) a foaming process begins near the mould centre, and spreads out to a mould edge.
the moulds are made of nickel alloys material.

There is further provided a plastic article produced using a process of concept E.

There is further provided a computer program product for running on a computer, wherein the computer program product running on a computer is operable to control a process of concept E.

F. Method of Manufacturing a Plastic Article with Efficient Heating and Rapid Cooling

A manufacturing cycle process for forming plastic into a predetermined shape from a plastic particulate material, and a heat-activated expandable foam plastic filler material, using manufacturing apparatus, the apparatus including

a mould comprising first and second complementary mould parts, the mould parts being formed into a predetermined shape with at least a face portion on each of said complementary first and second mould parts to impart a desired shape;

wherein the manufacturing cycle comprises

(i) starting with the mould parts in an open configuration, at a mould starting temperature;

(ii) moving the mould parts into a brought-together configuration,

(iii) heating said first and second mould parts at least on their face portions to an elevated temperature of from about 100° C. to about 500° C. such that the mould parts are at a temperature to make the plastic particulate material molten or sinterable;

(iv) opening the mould parts into an open configuration;

(v) contacting the first and second mould parts with plastic particulate material;

(vi) contacting the heat-activated expandable foam plastic filler material to the plastic particulate material on a face portion of at least one of the two complementary heated mould parts;

(vii) melting or sintering at least a portion of the plastic particulate material on each mould part into a moulded skin of a plastic article;

(viii) bringing together the complementary face portions of the heated first and second mould parts whereby the heat from the heated mould parts will activate the heat-activated expandable foam plastic filler material to cause it to form a composite sandwich such that an article is formed having a moulded surface on both sides;

(ix) opening the mould parts into an open configuration;

(x) cooling the mould parts, and

(xi) removing the plastic article from the mould.

Further features may include:
mould starting temperature in step (i) is between room temperature and about 100° C.
actively heating the mould parts in step (iv).
in step (vii), skin has a desired thickness of from about 0.001 cm to about 3.0 cm.
in step (x), the mould parts are cooled to below 100° C. the manufacturing cycle time is less than 90 minutes.
Manufacturing cycle process includes a step wherein between steps (viii) and (ix), the article is cooled to a temperature greater than the starting temperature.
Any feature of Concept D above.
Any feature in a Claim of this application.

There is further provided a plastic article produced using a process of concept F.

There is further provided a computer program product for running on a computer, wherein the computer program product running on a computer is operable to control a process of concept F.

G. Method of Manufacturing Plastic Article (eg. a Board) with at Least One Extra Outer Skin, with Time-Efficient Deposition of Component Materials

A process for forming plastic into a predetermined shape from a plastic particulate material, and a heat-activated expandable foam plastic filler material, and a first outer skin material and a second outer skin material, the process comprising the steps of:

(i) providing first and second complementary mould parts, the mould parts being formed into a predetermined shape with at least a face portion on each of said complementary first and second mould parts to impart a desired shape;

(ii) contacting the first and second mould parts respectively with the first outer skin and the second outer skin materials;

(iii) contacting at least one of the first outer skin and the second outer skin materials with plastic particulate material;

(iv) contacting the heat-activated expandable foam plastic filler material to the plastic particulate or an outer skin material on a face portion of at least one of the two complementary heated mould parts;

(v) heating said first and second mould parts at least on their face portions to melt or to sinter at least a portion of the first outer skin material and the second outer skin material on each respective mould part into a moulded skin of a plastic article having a skin of a desired thickness, and melting or sintering at least a portion of the plastic particulate material into an inner skin of a plastic article having a skin of a desired thickness;

(vi) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

Further features may include:
heating said first and second mould parts at least on their face portions to an elevated temperature of from about 100° C. to about 865° C. such that the mould parts are at a temperature to make the first outer skin material, the second outer skin material and the plastic particulate material molten or sinterable.
skin of a desired thickness of from about 0.001 cm to about 3.0 cm.
step (iii) is performed essentially immediately after step (ii), to provide time-efficient deposition of component materials.
step (iv) is performed essentially immediately after step (iii), to provide time-efficient deposition of component materials.
Any feature of concept B above.
Any feature in a Claim of this application.

There is further provided a plastic article produced using a process of concept G.

There is further provided a computer program product for running on a computer, wherein the computer program product running on a computer is operable to control a process of concept G.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A process for forming plastic into a predetermined shape from a plastic particulate material, and a heat-activated expandable foam plastic filler material, the process comprising the steps of:
(i) providing first and second complementary mould parts, the mould parts being formed into a predetermined shape with at least a face portion on each of said complementary first and second mould parts to impart a desired shape;
(ii) heating said first and second mould parts at least on their face portions to an elevated temperature of from about 100° C. to about 500° C. such that the mould parts are at a temperature to make the plastic particulate material molten or sinterable;
(iii) contacting the first and second mould parts with plastic particulate material;
(iv) contacting the heat-activated expandable foam plastic filler material to the plastic particulate material on a face portion of at least one of the two complementary heated mould parts;
(v) melting or sintering at least a portion of the plastic particulate material on each mould part into a moulded skin of a plastic article having a skin of a desired thickness of from about 0.001 cm to about 3.0 cm, and
(vi) bringing together the complementary face portions of the heated first and second mould parts whereby the heat from the heated mould parts will activate the heat-activated expandable foam plastic filler material to cause it to form a composite sandwich such that an article is formed having a moulded surface on both sides.

2. Process of claim 1, wherein the plastic particulate material is recycled plastic.

3. Process of claim 2, wherein the recycled plastic is comingled contaminated recycled plastic.

4-8. (canceled)

9. Process of claim 1, wherein the heating in step (ii) is performed with the mould closed, and when a target temperature is reached, the mould is opened for application of plastic particulate material.

10. Process of claim 1, wherein during step (vi) the first and second mould parts are actively heated.

11. (canceled)

12. Process of claim 1, wherein the quantities of plastic particulate material and heat-activated expandable foam plastic filler material used are such that when those materials are fully expanded, the volume of the article is greater than the volume of the mould, and wherein some material from the article oozes out the mould as the article is formed.

13-14. (canceled)

15. Process of claim 1, wherein a maximum temperature in step (ii) is one of: 400° C., 300° C., 260° C., 250° C., or 200° C.

16. (canceled)

17. Process of claim 1, wherein the moulds are made of a material selected from the group consisting of aluminium, aluminium alloys, stainless steel, kirksite, metals, ceramics, cermets, high temperature plastics, formable heat resistant materials, nickel alloys, or pyrex glass.

18. Process of claim 1, wherein the plastic article is a board.

19. Process of claim 18, wherein the board is no less than 2 feet×2 feet.

20-22. (canceled)

23. Process of claim 18, wherein the board is no thinner than 4 mm.

24. Process of claim 18, wherein the board includes inserts in the core or skin layers.

25. Process of claim 18, wherein the board includes inserts on top of the skin layers or between the core and skin layers.

26. (canceled)

27. Process of claim 1, wherein the heat-activated expandable foam plastic filler material includes heat-activated expandable foamable plastic filler material.

28. Process of claim 1, wherein during step (vi), during core foaming, the core bonds to the skins.

29-30. (canceled)

31. Process of claim 1, wherein during step (vi) the mould is first closed, wherein foaming of the core causes a pressure-induced leakage from the mould above a threshold pressure, and wherein the threshold pressure is in the range 0.5 bar to 5 bar in excess of atmospheric pressure.

32. Process of claim 1, wherein the process is a manufacturing process tolerant to the compositions of the plastic particulate material and the heat-activated expandable foam plastic filler material.

33-34. (canceled)

35. Computer program product for running on a computer, wherein the computer program product running on a computer is operable to control a process of claim 1.

36. Plastic article board comprising recycled plastic, the board comprising a core, an upper skin layer and a lower skin layer, the core bonded to the upper skin layer and to the lower skin layer, the board having an area no less than 2 feet×2 feet, and no greater than 15 feet×10 feet, wherein the board is no thicker than 200 mm and no thinner than 4 mm, wherein the board thickness non-uniformity across the board is less than ±5%.

37. Board of claim 36, wherein the board thickness non-uniformity across the board is less than ±2.5%.

38-40. (canceled)
